(19) United States
(12) Patent Application Publication
(10) Pub. No.: US 2023/0403767 A1
(43) Pub. Date: Dec. 14, 2023

(54) METHOD AND APPARATUS FOR ELECTROMAGNETIC INDUCTION

(71) Applicant: Samsung Electronics Co., Ltd., Suwon-si (JP)

(72) Inventors: Seisaku OOSAKO, Yokohama-shi (JP); Yutaka YAGI, Yokohama-shi (JP)

(73) Assignee: Samsung Electronics Co., Ltd., Suwon-si, Gyeonggi-do (KR)

(21) Appl. No.: 18/239,976

(22) Filed: Aug. 30, 2023

Related U.S. Application Data
(63) Continuation of application No. PCT/KR2022/002786, filed on Feb. 25, 2022.

(30) Foreign Application Priority Data
Mar. 4, 2021 (JP) 2021-034136

(51) Int. Cl. H05B 6/12; H02J 50/10; H02J 50/80; H02J 50/50; H04B 5/00

(52) U.S. Cl. CPC H05B 6/12; H02J 50/10; H02J 50/80; H02J 50/50; H04B 5/0037; H04B 5/0075

(57) ABSTRACT

An electromagnetic induction device including a wireless power transmission unit including an induction coil configured to generate a magnetic flux in an up-down direction to heat an external device located above the indication coil by induction heating, and a communication unit including a communication coil configured to output a carrier wave, and a relay circuit configured to resonate at a frequency of the carrier wave, to wirelessly communicate with the external device.

### TECHNICAL FIELD

The present disclosure relates to an electromagnetic induction device for heating an object to be heated or supplying power to a power supply object by using electromagnetic induction, and more particularly, to a relay circuit for improving communication performance between an electronic induction device and an external device.

### BACKGROUND ART

Recently, in order to ensure safety and improve convenience in kitchen appliances and the like, a function of performing wireless power supply (or charging) without electrical contact or performing wireless communication between kitchen devices or between a kitchen device and a cooking device (e.g., a pot) is added by using short-range wireless communication (e.g., near-field communication (NFC)). In NFC, power transmission or communication transmission is performed by magnetic coupling between a transmission coil and a reception coil.

### DISCLOSURE

### Technical Problem

Among kitchen appliances, there is an induction stove (induction heating (IH) cooking heater) in which an insulator sheet such as a mica sheet is provided on a working coil (or an induction coil) under a glass upper plate to prevent a user from getting an electric shock. Because a distance between the mica sheet and the top plate is 1 mm or less, which is very close, and a control circuit is generally located under the working coil, the insulator sheet acts as an element that interferes with communication with an external device or application. In order to solve this problem, when a relay antenna is buried in the glass upper plate, a lot of cost is incurred.

Because the insulator sheet (e.g., the mica sheet) included in the induction stove in order to prevent the user from getting an electric shock is inexpensive, when the relay antenna is designed in the insulator sheet, a small cost is incurred and a thickness is small, and thus, the relay antenna may be located between the top plate and the working coil without greatly affecting a size of a product. Also, even when the insulator sheet including the relay antenna is located over the working coil, because the insulator sheet does not require electrical contact, the insulator sheet may be electrically insulated from the working coil that is a live part, thereby maintaining safety.

### Technical Solution

According to an embodiment of the present disclosure, an electromagnetic induction device may include a wireless power transmission unit including an induction coil configured to generate a magnetic flux in an up-down direction to heat an external device located above the induction coil by induction heating, and a communication unit including a communication coil configured to output a carrier wave, and a relay circuit configured to resonate at a frequency of the carrier wave, to wirelessly communicate with the external device.

According to an embodiment of the present disclosure, the carrier wave may have a frequency different from a driving frequency of the induction coil, the communication coil may be located under the induction coil and aligned with the induction coil so that the carrier wave is output in a direction orthogonal to the induction coil, and the relay circuit may be located over the induction coil and aligned with the induction coil.

According to an embodiment of the present disclosure, the relay circuit may be on a surface of a dielectric that is plate-like or sheet-like.

According to an embodiment of the present disclosure, the relay circuit may include a relay coil, a first surface electrode on a front surface of the dielectric, connected to a first end of the relay coil, and surrounding the relay coil, and a first rear electrode on a rear surface of the dielectric and facing the first surface electrode.

According to an embodiment of the present disclosure, the relay circuit may further include a second surface electrode on the front surface of the dielectric and connected to a second end of the relay coil, and a second rear electrode on the rear surface of the dielectric, connected to the first rear electrode, and facing the second surface electrode.

According to an embodiment of the present disclosure, the relay circuit may further include a connection wiring between the first rear electrode and the second rear electrode, and extending orthogonally to a wiring constituting the relay coil.

According to an embodiment of the present disclosure, the relay circuit may include a relay coil having an outer diameter greater than an outer diameter of the induction coil.

According to an embodiment of the present disclosure, a method of operating an electromagnetic induction device is provided, the electromagnetic induction device including a wireless power transmission unit that includes an induction coil configured to generate a magnetic flux in an up-down direction, and a communication unit that includes a communication coil configured to output a carrier wave, and a relay circuit configured to resonate at a frequency of the carrier wave, and the method may include driving the induction coil to generate the magnetic flux so that an external device located above the induction coil is heated by induction heating; and driving the communication coil to output the carrier wave, and resonating the relay circuit at the frequency of a carrier wave, to wireless communicate with the external device.

According to an embodiment of the present disclosure, the carrier wave may have a frequency different from a driving frequency of the induction coil, the communication coil may be located under the induction coil and aligned with the induction coil so that the carrier wave is output in a direction orthogonal to the induction coil, and the relay circuit may be located over the induction coil and aligned with the induction coil.

According to an embodiment of the present disclosure, the relay circuit may be on a surface of a dielectric that is plate-like or sheet-like.

According to an embodiment of the present disclosure, the relay circuit may include a relay coil, a first surface electrode on a front surface of the dielectric, connected to a first end of the relay coil, and surrounding the relay coil, and a first rear electrode on a rear surface of the dielectric and facing the first surface electrode.

According to an embodiment of the present disclosure, the relay circuit may further include a second surface electrode on the front surface of the dielectric and connected to a second end of the relay coil, and a second rear electrode on the rear surface of the dielectric, connected to the first rear electrode, and facing the second surface electrode.

According to an embodiment of the present disclosure, the relay circuit may further include a connection wiring between the first rear electrode and the second rear electrode, and extending orthogonal to a wiring constituting the relay coil.

According to an embodiment of the present disclosure, the relay circuit may include a relay coil having an outer diameter greater than an outer diameter of the induction coil.

According to an embodiment of the present disclosure, a non-transitory computer-readable recording medium has recorded thereon a computer program for executing a method as described above.

### DESCRIPTION OF DRAWINGS

FIG. 1 is a view for describing an electromagnetic induction system, according to an embodiment of the present disclosure.

FIG. 2A is a view for describing a type of a cooking device, according to an embodiment of the present disclosure.

FIG. 2B is a view for describing a type of a cooking device, according to an embodiment of the present disclosure.

FIG. 2C is a view for describing a type of a cooking device, according to an embodiment of the present disclosure.

FIG. 3A is a block diagram for describing a function of an electromagnetic induction device, according to an embodiment of the present disclosure.

FIG. 3B is a block diagram for describing a function of an electromagnetic induction device, according to an embodiment of the present disclosure.

FIG. 4 is a view for describing a wireless power transmission unit of an electromagnetic induction device (wireless power transmission device), according to an embodiment of the present disclosure.

FIG. 5A is a perspective view of an electromagnetic induction device, according to an embodiment of the present disclosure.

FIG. 5B is a cross-sectional view of an electromagnetic induction device, according to an embodiment of the present disclosure.

FIG. 6 is a side view illustrating a configuration of a relay unit, according to an embodiment of the present disclosure.

FIG. 7 is a top view or bottom view of a relay unit, according to an embodiment of the present disclosure.

FIG. 8 is an equivalent circuit diagram illustrating an electromagnetic induction system including a relay unit, according to an embodiment of the present disclosure.

FIG. 9 illustrates a configuration of a relay unit, according to an embodiment of the present disclosure.

FIG. 10 illustrates a configuration of a relay unit, according to an embodiment of the present disclosure.

FIG. 11 illustrates a configuration of an electromagnetic induction device, according to an embodiment of the present disclosure.

FIG. 12 is a flowchart of an electromagnetic induction method, according to an embodiment of the present disclosure.

### MODE FOR INVENTION

Hereinafter, various embodiments of the present disclosure will be described in detail with reference to the accompanying drawings.

While describing embodiments of the present disclosure, descriptions of techniques that are well known in the art and not directly related to the present disclosure are omitted. This is to clearly convey the gist of the present disclosure by omitting any unnecessary description.

For the same reason, some elements in the accompanying drawings are exaggerated, omitted, or schematically illustrated. Also, the size of each element may not substantially reflect its actual size. In the drawings, the same or corresponding elements are denoted by the same reference numerals.

The advantages and features of the present disclosure and methods of achieving them will become apparent with reference to embodiments of the present disclosure described in detail below along with the attached drawings. In this regard, the embodiments of the present disclosure may have different forms and should not be construed as being limited to the descriptions set forth herein. Rather, these embodiments of the present disclosure are provided so that this disclosure will be thorough and complete and will fully convey the concept of the present embodiments of the present disclosure to one of ordinary skill in the art, and the present disclosure will only be defined by the appended claims. In the specification, the same reference numerals denote the same elements.

It will be understood that each block of flowchart illustrations and combinations of blocks in the flowchart illustrations may include computer program instructions. Because these computer program instructions may be loaded into a processor of a general-purpose computer, special purpose computer, or other programmable data processing equipment, the instructions, which are executed via the processor of the computer or other programmable data processing equipment generate means for performing the functions specified in the flowchart block(s). Because these computer program instructions may also be stored in a computer-executable or computer-readable memory that may direct the computer or other programmable data processing equipment to function in a particular manner, the instructions stored in the computer-executable or computer-readable memory may produce an article of manufacture including instruction means for performing the functions stored in the flowchart block(s). Because the computer program instructions may also be loaded into a computer or other programmable data processing equipment, a series of operational steps may be performed on the computer or other programmable data processing equipment to produce a computer implemented process, and thus, the instructions executed on the computer or other programmable data processing equipment may provide steps for implementing the functions specified in the flowchart block(s).

Also, each block may represent a module, segment, or portion of code, which includes one or more executable instructions for implementing specified logical function(s). It should also be noted that in some alternative implementations, the functions noted in the blocks may occur out of order. For example, two blocks shown in succession may in fact be executed substantially concurrently or the blocks may sometimes be executed in reverse order, depending upon the functionality involved.

Furthermore, the term “ . . . unit” as used herein refers to a software or hardware component, such as a field programmable gate array (FPGA) or application specific integrated circuit (ASIC) which plays a certain role. However, the term “ . . . unit” is not meant to be limited to software or hardware. A “ . . . unit” may be configured to be in an addressable storage medium or may be configured to operate one or more processors. Accordingly, a “ . . . unit” may include, by way of example, components, such as software components, object-oriented software components, class components, and task components, processes, functions, attributes, procedures, subroutines, segments of program code, drivers, firmware, microcode, circuitry, data, databases, data structures, tables, arrays, and variables. The functionality provided in components and “ . . . units“may be combined into fewer elements and” . . . units” or may be further separated into additional components and “ . . . units”. Furthermore, components and “ . . . units” may be implemented to operate one or more central processing units (CPUs) in a device or a secure multimedia card. Also, a “ . . . unit” in an embodiment may include one or more processors.

The present disclosure will be described in detail with reference to the attached drawings.

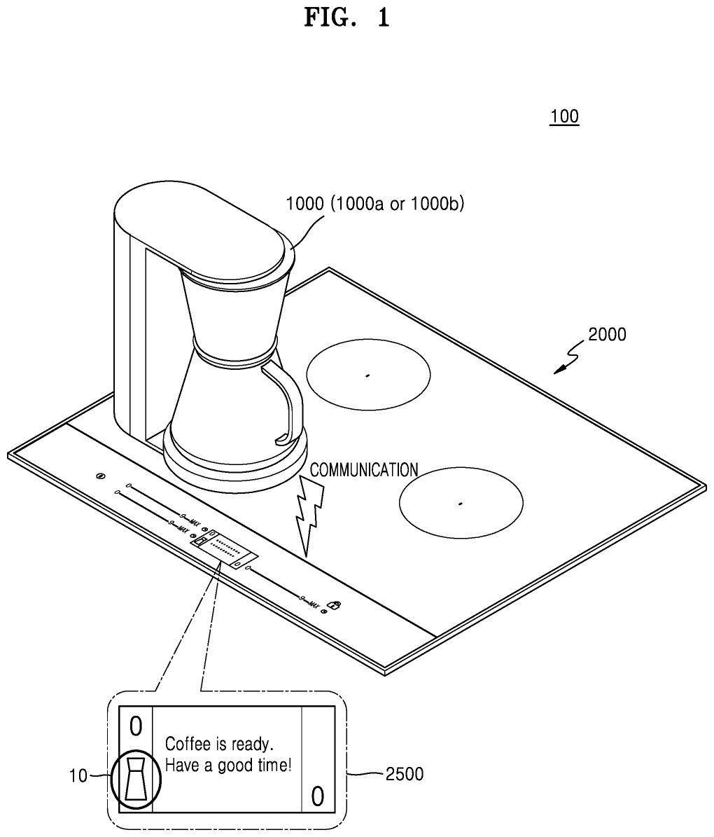

FIG. 1 is a view for describing an electromagnetic induction system, according to an embodiment of the present disclosure.

Referring to FIG. 1, an electromagnetic induction system 100 according to an embodiment of the present disclosure may include a cooking device 1000 and an electromagnetic induction device 2000. The electromagnetic induction device 2000 according to an embodiment of the present disclosure may be referred to as a heating device or a wireless power transmission device. However, not all of the illustrated elements are essential elements. The electromagnetic induction system 100 may include more elements or fewer elements than the illustrated elements. For example, the electromagnetic induction system 100 may include the cooking device 1000, the electromagnetic induction device 2000, and a server device (not shown). Hereinafter, each element of the electromagnetic induction system 100 will be described.

The cooking device 1000 may be a device for heating contents in the cooking device 1000. The contents in the cooking device 1000 may be a liquid such as water, tea, coffee, soup, juice, wine, or oil, or a solid such as butter, meat, vegetables, bread, or rice, but are not limited thereto.

According to an embodiment of the present disclosure, the cooking device 1000 may wirelessly receive power from the electromagnetic induction device 2000 by using electromagnetic induction. Accordingly, the cooking device 1000 according to an embodiment of the present disclosure may not include a power line connected to a power outlet.

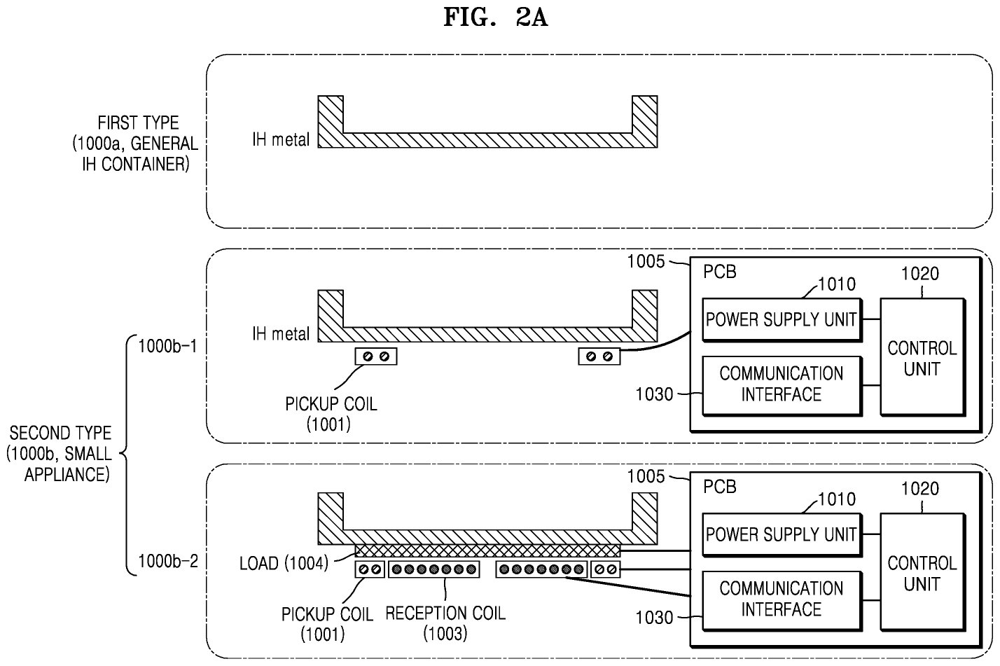

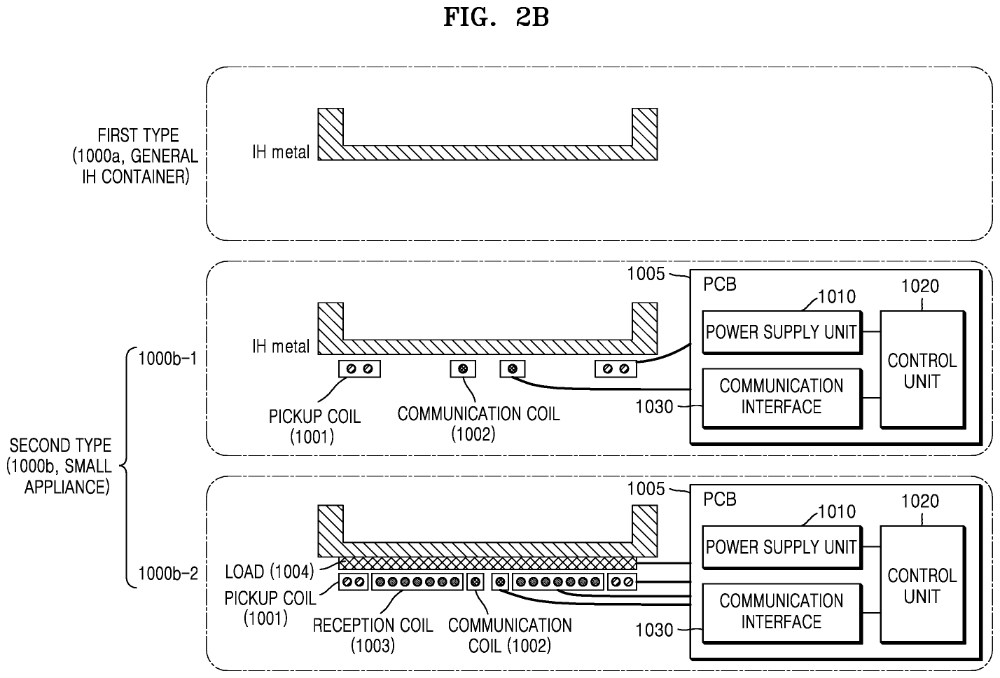

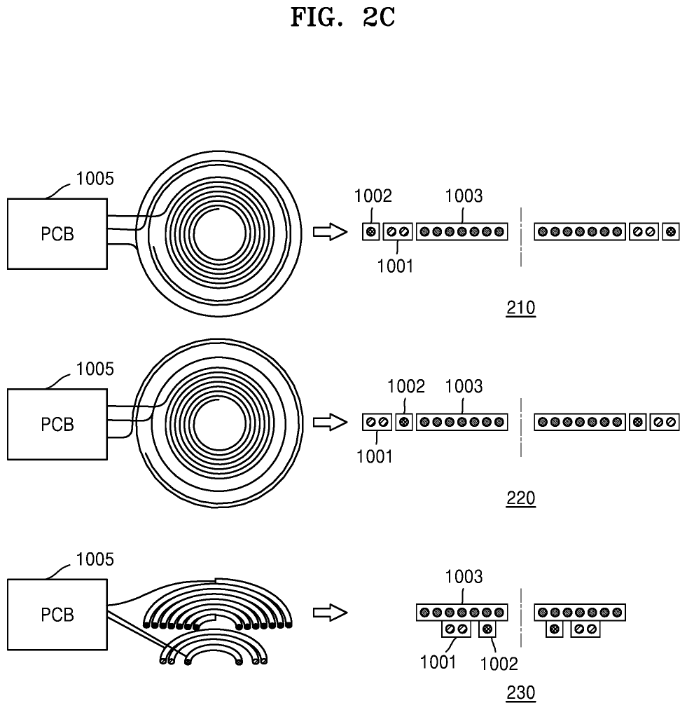

According to an embodiment of the present disclosure, there may be various types of cooking devices 1000 that wirelessly receive power from the electromagnetic induction device 2000. The cooking device 1000 may be a first type cooking device 1000a (see FIG. 2A), which is a general induction heating (IH) container including a magnetic body, or may be a second type cooking device 1000b (see FIG. 2A) including a communication interface. Hereinafter, the second type cooking device 1000b including the communication interface may be defined as a small appliance. Also, the second type cooking device 1000b may include a 2-1 type cooking device 1000b-1 including a magnetic body (IH metal) (e.g., an iron component) and a 2-2 type cooking device 1000b-2 including a reception coil. In the 2-1 type cooking device 1000b-1, a magnetic field may be induced in the container (IH metal) itself, and the second type cooking device 1000b-2 may induce a magnetic field in the reception coil. A type of the cooking device 1000 will be described below with reference to FIGS. 2A to 2C.

The cooking device 1000 may be a general IH container such as a pot, a frying pan, or a steamer, or a small appliance such as an electric kettle, a teapot, a coffee machine (or a coffee dripper), a toaster, a blender, an electric rice cooker, an oven, or an air fryer, but is not limited thereto. The cooking device 1000 may include a cooker device.

The cooker device may be a device in which a general IH harvesting container may be inserted or detached. According to an embodiment, the cooker device may be a device capable of automatically cooking contents according to a recipe. The cooker device may be referred to as a pot, a rice cooker, or a steamer according to its use. For example, when an inner pot capable of cooking rice is inserted into the cooker device, the cooker device may be referred to as a rice cooker. Hereinafter, the cooker device may be defined as a smart pot.

According to an embodiment of the present disclosure, when the cooking device 1000 is a small appliance including a communication interface, the cooking device 1000 may perform communication with the electromagnetic induction device 2000. The communication interface may include a short-range communication unit and a long-range communication unit. Examples of the short-range communication unit may include, but are not limited to, a Bluetooth communication unit, a Bluetooth low energy (BLE) communication unit, a near-field communication (NFC) unit, a wireless local area network (WLAN) (Wi-Fi) communication unit, a Zigbee communication unit, an infrared data association (IrDA) communication unit, a Wi-Fi direct (WFD) communication unit, an ultra-wideband (UWB) communication unit, and an Ant+ communication unit. The long-range communication unit may be used to communicate with a server device (not shown) when the cooking device is remotely controlled by the server device (not shown) in an Internet of Things (IoT) environment. Examples of the long-range communication unit may include the Internet, a computer network (e.g., LAN or WAN), and a mobile communication unit. Examples of the mobile communication unit may include, but are not limited to, a 3G module, a 4G module, a 5G module, an LTE module, and an NB-IoT module, an LTE-M module.

The cooking device 1000 according to an embodiment of the present disclosure may transmit identification information of the cooking device 1000 to the electromagnetic induction device 2000 through the communication interface. The identification information of the cooking device 1000, which is unique information for identifying the cooking device 1000, may include at least one of, but not limited to, a Mac address, a model name, device type information (e.g., an IH type ID, a heater type ID, or a motor type ID), manufacturer information (e.g., manufacture ID), a serial number, and manufacturing time information (date of manufacture). According to an embodiment of the present disclosure, the identification information of the cooking device 1000 may be expressed as a series of identification numbers or a combination of numbers and alphabet letters. According to an embodiment of the present disclosure, the cooking device 1000 may transmit the position information of the cooking device 1000 to the electromagnetic induction device 2000 through the communication interface. The position information of the cooking device 1000 may include information about a cooking zone (also referred to as a heating zone) in which the cooking device 1000 is located.

According to an embodiment of the present disclosure, the cooking device 1000 may transmit information to a server device (not shown) through the electromagnetic induction device 2000. For example, the cooking device 1000 may transmit information (e.g., temperature information of the contents) obtained from the cooking device 1000 to the electromagnetic induction device 2000 through short-range wireless communication (e.g., Bluetooth or BLE). In this case, the electromagnetic induction device 2000 may transmit the information obtained from the cooking device 1000 to the server device by connecting to the server device by using a WLAN (Wi-Fi) communication unit or a long-range communication unit (e.g., the Internet). Meanwhile, the server device may provide the information, which is obtained by the cooking device 1000 and received from the electromagnetic induction device 2000, to a user through a mobile terminal connected to the server device. According to another embodiment of the present disclosure, the electromagnetic induction device 2000 may directly transmit the information obtained from the cooking device 1000 to the mobile terminal of the user through device-to-device (D2D) communication (e.g., Wi-Fi direct (WFD) communication or BLE communication).

According to an embodiment of the present disclosure, the cooking device 1000 may directly transmit the information (e.g., temperature information of the contents) obtained from the cooking device 1000 to the server device through a communication interface (e.g., a WLAN (Wi-Fi) communication unit). Also, the cooking device 1000 may directly transmit the information (e.g., temperature information of the contents) obtained from the cooking device 1000 to the mobile terminal of the user through short-range wireless communication (e.g., Bluetooth or BLE) or device-to-device (D2D) communication (e.g., Wi-Fi direct (WFD) communication).

The electromagnetic induction device 2000 according to an embodiment of the present disclosure may be a device that wirelessly transmits power to an object to be heated (e.g., the cooking device 1000) located on a top plate by using electromagnetic induction. The electromagnetic induction device 2000 may be referred to as an induction range or an electric range. The electromagnetic induction device 2000 may include a working coil that generates a magnetic field for induction heating the cooking device 1000. When the cooking device 1000 is the 2-2 type cooking device 1000b-2 including a reception coil, the working coil may be referred to as a transmission coil. Alternatively, the working coil may be referred to as an induction coil or an electromagnetic induction coil.

When power is wirelessly transmitted, it may mean that power is transmitted by using a magnetic field induced in a reception coil or an IH metal (e.g., an iron component) through magnetic induction. For example, the electromagnetic induction device 2000 may generate an eddy current in the cooking device 1000 or cause a magnetic field to be induced in the reception coil by making current flow through the working coil (transmission coil) to form a magnetic field.

According to an embodiment of the present disclosure, the electromagnetic induction device 2000 may include a plurality of working coils. For example, when the top plate of the electromagnetic induction device 2000 includes a plurality of cooking zones, the electromagnetic induction device 2000 may include a plurality of working coils respectively corresponding to the plurality of cooking zones. Also, the electromagnetic induction device 2000 may include a high-power cooking zone in which a first working coil is provided on the inside and a second working coil is provided on the outside. The high-power cooking zone may include three or more working coils.

The top plate of the electromagnetic induction device 2000 according to an embodiment of the present disclosure may be formed of tempered glass such as ceramic glass so as not to be easily damaged. Also, a guide mark for guiding a cooking zone in which the cooking device 1000 should be located may be provided on the top plate of the electromagnetic induction device 2000.

The electromagnetic induction device 2000 according to an embodiment of the present disclosure may detect that the cooking device 1000 (e.g., the first type cooking device 1000a or the 2-1 type cooking device 1000b-1) including a magnetic body is placed on the top plate. For example, the electromagnetic induction device 2000 may detect that the cooking device 1000 is located on the top plate of the electromagnetic induction device 2000 based on a change in a current value (inductance) of the working coil by the approach of the cooking device 1000.

According to an embodiment of the present disclosure, the electromagnetic induction device 2000 may include a communication interface for performing communication with an external device. For example, the electromagnetic induction device 2000 may communicate with the cooking device 1000 or the server device through the communication interface. The communication interface may include a short-range communication unit (e.g., an NFC communication unit, a Bluetooth communication unit, or a BLE communication unit) and a mobile communication unit.

According to an embodiment of the present disclosure, the electromagnetic induction device 2000 may detect the cooking device 1000 located on the top plate through the communication interface. For example, the electromagnetic induction device 2000 may detect the cooking device 1000 by receiving a packet transmitted from the cooking device 1000 located on the top plate by using short-range wireless communication (e.g., BLE or Bluetooth). Because the second type cooking device 1000b including the communication interface may be defined as a small appliance (small thing), a mode in which the electromagnetic induction device 2000 detects the cooking device 1000 through the communication interface will hereinafter be defined as a “small appliance detection mode”.

According to an embodiment of the present disclosure, the electromagnetic induction device 2000 may receive identification information of the cooking device 1000 from the cooking device 1000 by using short-range wireless communication (e.g., BLE communication or Bluetooth communication). In this case, the cooking device 1000 may be the second type cooking device 1000b (small appliance) including the communication interface. Also, when the electromagnetic induction device 2000 outputs power according to a different power transmission pattern for each cooking zone, the electromagnetic induction device 2000 may receive information about a first cooking zone corresponding to a first power transmission pattern detected by the cooking device 1000 together with identification information of the cooking device 1000. Here, the first cooking zone may be a cooking zone in which the cooking device 1000 is located among a plurality of cooking zones included in the electromagnetic induction device 2000. Referring to FIG. 1, the first cooking zone may be a lower left cooking zone in which the cooking device 1000 is located.

According to an embodiment of the present disclosure, the electromagnetic induction device 2000 may display information related to the cooking device 1000 through a user interface 2500. For example, when the cooking device 1000 is detected, the electromagnetic induction device 2000 may display identification information of the cooking device 1000 and position information of the cooking device 1000 on a display unit included in the user interface 2500. Referring to FIG. 1, when a user places the cooking device 1000 (e.g., a coffee dripper) on the top plate of the electromagnetic induction device 2000, the electromagnetic induction device 2000 may display a coffee dripper icon 10 on the display unit at a position corresponding to the lower left cooking zone, thereby providing the user with identification information (e.g., coffee dripper) of the cooking device 1000 and position information of the cooking device 1000 (e.g., position in the lower left cooking zone).

According to an embodiment of the present disclosure, the electromagnetic induction device 2000 may provide a graphical user interface (GUI) corresponding to the identification information of the cooking device 1000 through the user interface 2500. For example, when the cooking device 1000 is a coffee dripper and an operation of the coffee dripper is completed, the electromagnetic induction device 2000 may output text such as “Coffee is ready. Have a good time”.

According to the electromagnetic induction system 100 according to an embodiment of the present disclosure, even when the user simply places the cooking device 1000 on the electromagnetic induction device 2000, the electromagnetic induction device 2000 may automatically identify a type of the cooking device 1000 and a position of the cooking device 1000 and may provide an appropriate GUI to the user, thereby increasing user convenience. Hereinafter, a type of the cooking device 1000 according to an embodiment of the present disclosure will be described in detail with reference to FIGS. 2A to 2C.

FIGS. 2A, 2B, and 2C are views illustrating a type of a cooking device, according to an embodiment of the present disclosure.

Referring to FIG. 2A, the cooking device 1000 may include the first type cooking device 1000a, which is a general IH container including a magnetic body (e.g., an IH metal), and the second type cooking device 1000b capable of communicating with the electromagnetic induction device 2000. The second type cooking device 1000b capable of communicating with the electromagnetic induction device 2000 may be defined as a small appliance. According to an embodiment of the present disclosure, the second type cooking device 1000b may be classified into the 2-1 type cooking device 1000b-1 including an IH metal (e.g., an iron component) and the 2-2 type cooking device 1000b-2 including a reception coil 1003. Each type will be described.

The first type cooking device 1000a may be induction heated by the electromagnetic induction device 2000, and may be any of various types of containers including a magnetic body. Induction heating (IH) is a method of heating an IH metal by using electromagnetic induction. For example, when alternating current is supplied to the working coil of the electromagnetic induction device 2000, a magnetic field that changes with time is induced in the working coil. In this case, the working coil may be referred to as an induction coil or an electromagnetic induction coil.

The magnetic field generated by the working coil passes through a bottom surface of the first type cooking device 1000a. When the magnetic field the changes with time passes through the IH metal (e.g., iron, steel nickel, or various types of alloys) included in the bottom surface of the first type cooking device 1000a, current rotating around the magnetic field is generated in the IH metal. Rotating current is referred to as eddy current, and a phenomenon in which current is induced by a magnetic field that changes with time is referred to as electromagnetic induction. When the cooking device 1000 is the first type cooking device 1000a, heat is generated at the bottom surface of the first type cooking device 1000a due to the resistance of the eddy current and the IH metal (e.g., iron). In this case, the contents of the first type cooking device 1000a may be heated by the generated heat.

The second type cooking device 1000b may include a pickup coil 1001, a power supply unit 1010, a control unit 1020, and a communication interface 1030. In this case, the power supply unit 1010, the control unit 1020, and the communication interface 1030 may be mounted on a printed circuit board (PCB) 1005. The pickup coil 1001 may be a low power coil for generating power for operating the PCB 1005. When power is supplied to the PCB 1005 through the pickup coil 1001, components mounted on the PCB 1005 may be activated. For example, when power is supplied to the PCB 1005 through the pickup coil 1001, the power supply unit 1010, the control unit 1020, and the communication interface 1030 may be activated.

Referring to FIG. 2B, the second type cooking device 1000b may further include a communication coil 1002. The communication coil 1002 is a coil for performing short-range wireless communication with the electromagnetic induction device 2000. For example, the communication coil 1002 may be an NFC antenna coil for NFC communication. Although the number of turns of the communication coil 1002 is one in FIG. 2B, the present disclosure is not limited thereto. The number of turns of the communication coil 1002 may be plural. For example, the communication coil 1002 may be wound 5 to 6 times. The NFC circuit connected to the NFC antenna coil may receive power through the pickup coil 1001. Hereinafter, the elements will be sequentially described.

The power supply unit 1010 may be a switched mode power supply (SMPS) that receives alternating current power from the pickup coil 1001 and supplies direct current power to the control unit 1020 or the communication interface 1030. Also, the power supply unit 1010 may include an inverter and/or a converter that, when alternating current or direct current power, rather than commercial alternating current power, is required in another component in the second type cooking device 1000b as well as the control unit 1020 and the communication interface 1030, supplies the alternating current or direct current power.

The power supply unit 1010 may include a rectifier (rectifier circuit) for converting alternating current power into direct current power. The rectifier may convert an alternating current voltage whose magnitude and polarity (positive voltage or negative voltage) change with time into a direct current voltage whose magnitude and polarity are constant, and may convert alternating current whose magnitude and direction (positive current or negative current) change with time into direct current whose magnitude is constant. The rectifier may include a bridge diode. The bridge diode may convert an alternating current voltage whose polarity changes with time into a positive voltage whose polarity is constant, and convert alternating current whose direction changes with time into positive current whose direction is constant. The rectifier may include a direct current (DC) link capacitor. The DC link capacitor may convert a positive voltage whose magnitude changes with time into a direct current voltage whose magnitude is constant. The inverter connected to the DC link capacitor may generate alternating current power of various frequencies and sizes required by the second type cooking device 1000b, and the converter may generate direct current power of various sizes required by the second type cooking device 1000b.

The control unit 1020 may include at least one processor, and the at least one processor may control an overall operation of the second type cooking device 1000b. For example, the at least one processor included in the control unit 1020 may control the power supply unit 1010, and the communication interface 1030.

According to an embodiment of the present disclosure, the control unit 1020 may identify a current position of the second type cooking device 1000b by detecting a power transmission pattern of power received from the electromagnetic induction device 2000 through the power supply 1010. For example, the control unit 1020 may compare a pre-stored power transmission pattern for each cooking zone with the detected power transmission pattern and determine which cooking zone corresponds to the detected power transmission pattern. The second type cooking device 1000b may further include a voltage sensor for detecting a power transmission pattern.

The control unit 1020 may control the communication interface 1030 to transmit or receive data. For example, the control unit 1020 may control the communication interface 1030 to transmit at least one of identification information of the second type cooking device 1000b, position information of the second type cooking device 1000b, and communication connection information of the second type cooking device 1000b to the electromagnetic induction device 2000.

According to an embodiment of the present disclosure, when the second type cooking device 1000b includes a temperature sensor, the control unit 1020 may control the temperature sensor. For example, the control unit 1020 may measure a temperature of the contents in the second type cooking device 1000b and control the temperature sensor to transmit a measurement result to the control unit 1020. Also, the control unit 1020 may control the temperature sensor to monitor a temperature of the contents at regular intervals. The control unit 1020 may control the communication interface 1030 to transmit temperature information of the contents to the electromagnetic induction device 2000 through short-range wireless communication.

The communication interface 1030 may include one or more elements that allow communication between the second type cooking device 1000b and the electromagnetic induction device 2000, between the second type cooking device 1000b and a server device (not shown), or between the second type cooking device 1000b and a mobile terminal (not shown). The communication interface 1030 may include a short-range communication unit and a long-range communication unit.

Examples of the short-range communication unit may include, but are not limited to, a Bluetooth communication unit, a Bluetooth low energy (BLE) communication unit, a near-field communication (NFC) unit, a wireless local area network (WLAN) (Wi-Fi) communication unit, a Zigbee communication unit, an infrared data association (IrDA) communication unit, a Wi-Fi direct (WFD) communication unit, an ultra-wideband (UWB) communication unit, and an Ant+ communication unit. The long-range communication unit may be used to communicate with a server device (not shown) when the second type cooking device 1000b is remotely controlled by the server device (not shown) in an Internet of Things (IoT) environment. Examples of the long-range communication unit may include the Internet, a computer network (e.g., LAN or WAN), and a mobile communication unit. Examples of the mobile communication unit may include, but are not limited to, a 3G module, a 4G module, a 5G module, an LTE module, an NB-IoT module, and an LTE-M module.

According to an embodiment of the present disclosure, the second type cooking device 1000b may transmit information to the server device through the electromagnetic induction device 2000. For example, the second type cooking device 1000b may transmit information (e.g., temperature information of the contents) obtained from the second type cooking device 1000b to the electromagnetic induction device 2000 through short-range wireless communication (e.g., Bluetooth or BLE). In this case, the electromagnetic induction device 2000 may transmit information (e.g., temperature information of the contents) obtained from the second type cooking device 1000b to the server device by connecting to the server device through a WLAN (Wi-Fi) communication unit and a long-range communication unit (Internet). Meanwhile, the server device may provide the information obtained from the second type cooking device 1000b and received from the electromagnetic induction device 2000 to a user through a mobile terminal connected to the server device. According to another embodiment of the present disclosure, the electromagnetic induction device 2000 may directly transmit the information obtained from the cooking device 1000 to the mobile terminal of the user through device-to-device (D2D) communication (e.g., Wi-Fi direct (WFD) communication or BLE communication).

Meanwhile, not all of the elements illustrated in FIG. 2 are essential elements. The second type cooking device 1000b may include more elements or fewer elements than the illustrated elements. For example, the second type cooking device 1000b may further include a sensor unit, a user interface, a memory, and a battery, in addition to the power supply unit 1010, the control unit 1020, and the communication interface 1030. Here, the user interface may include an input interface for receiving the user's input and an output interface for outputting information. The output interface is for outputting a video signal or an audio signal. The output interface may include a display unit, a sound output unit, and a vibration motor. When the display unit and a touch pad have a layer structure to form a touch screen, the display unit may be used as the input interface in addition to the output interface. The sound output unit may output audio data received through the communication interface 1030 or stored in a memory (not shown).

According to an embodiment of the present disclosure, when the second type cooking device 1000b includes a battery, the battery may be used as auxiliary power. For example, when the second type cooking device 1000b provides a warming function, the second type cooking device 1000b may monitor a temperature of the contents by using power of the battery even when power transmission from the electromagnetic induction device 2000 is stopped. When a temperature of the content is lower than a threshold temperature, the second type cooking device 1000b may transmit a notification to the mobile terminal using power of the battery or request the electromagnetic induction device 2000 to transmit power.

Also, before the second type cooking device 1000b receives power from the electromagnetic induction device 2000, the communication interface 1030 may be driven by using power of the battery and a wireless communication signal may be transmitted to the electromagnetic induction device 2000 so that the electromagnetic induction device 2000 recognizes the second type cooking device 1000b in advance. Examples of the battery may include, but are not limited to, a secondary battery (e.g., a lithium ion battery, a nickel/cadmium battery, a polymer battery, or a nickel-hydride battery) and a supercapacitor. A supercapacitor that is a high-capacity capacitor is called an ultra-capacitor.

According to an embodiment of the present disclosure, when the second type cooking device 1000b includes a memory, the memory may store a program for processing and control of a processor, or may store input/output data (e.g., power transmission pattern information for each cooking zone or identification information of the second type cooking device 1000b).

The memory may include at least one type of storage medium of a flash memory type storage unit, a hard disk type storage unit, a multimedia card micro type storage unit, a card type memory (e.g., an SD or XD memory), a random-access memory (RAM), a static random-access memory (SRAM), a read-only memory (ROM), an electrically erasable programmable read-only memory (EEPROM), a programmable read-only memory (PROM), a magnetic memory, a magnetic disk, and an optical disk. Programs stored in the memory may be classified into a plurality of modules according to their functions. The memory may store at least one artificial intelligence model.

Meanwhile, according to an embodiment of the present disclosure, the second type cooking device 1000b may include the 2-1 type cooking device 1000b-1 including an IH metal (e.g., an iron component) and the 2-2 type cooking device 1000b-2 including the reception coil 1003. In the case of the 2-1 type cooking device 1000b-1, the contents in the 2-1 type cooking device 1000b-1 may be heated by generating eddy current in the IH metal of the 2-1 type cooking device 1000b-1, like in the first type cooking device 1000a that is a general IH container. Examples of the 2-1 type cooking device 1000b-1 may include, but are not limited to, a smart kettle and an electric rice cooker (smart pot).

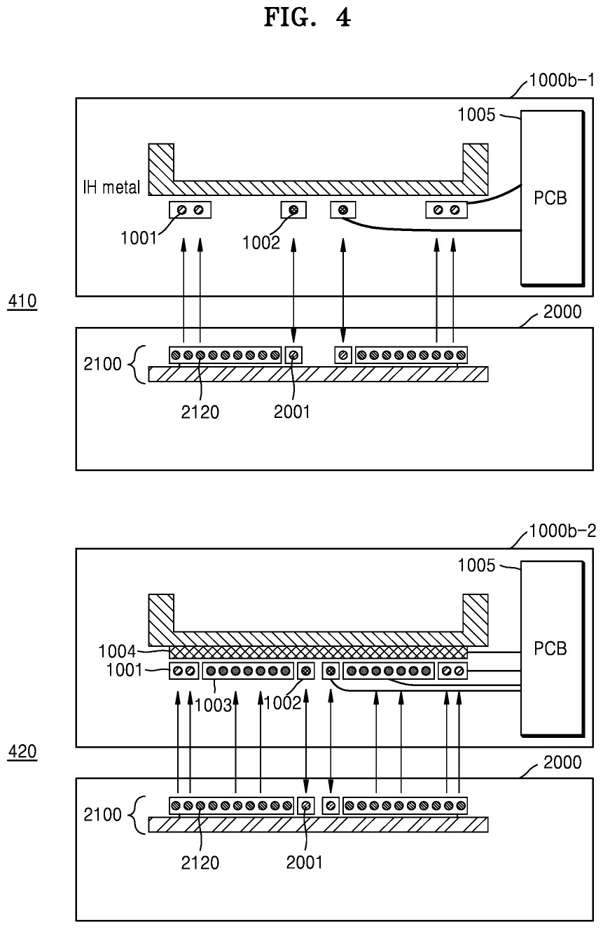

The 2-2 type cooking device 1000b-2 may further include the reception coil 1003 and a load 1004 than the 2-1 type cooking device 1000b-1. The reception coil 1003 may be a coil that receives wireless power transmitted from the electromagnetic induction device 2000 and drives the load 1004. For example, as a magnetic field generated from current flowing through a transmission coil (a working coil 2120 of FIG. 4 of the electromagnetic induction device 2000 passes through the reception coil 1003, induced current may flow through the reception coil 1003 to supply energy to the load 1004. Hereinafter, when induced current flows through the reception coil 1003 due to a magnetic field generated in the transmission coil (the working coil 2120), it may be expressed that the reception coil 1003 receives wireless power from the transmission coil (the working coil 2120). According to an embodiment of the present disclosure, the reception coil 1003 may have a concentric circle shape or an elliptical shape, but is not limited thereto.

According to an embodiment of the present disclosure, a plurality of reception coils 1003 may be provided. For example, the 2-2 type cooking device 1000b-2 may include a reception coil for a warming heater and a reception coil for a heating heater. In this case, the reception coil for the heating heater may drive the heating heater and the reception coil for the warming heater may drive the warming heater.

According to an embodiment of the present disclosure, in the 2-2 type cooking device 1000b-2, the pickup coil 1001, the communication coil 1002, and the reception coil 1003 may be located on the same layer. For example, referring to FIG. 2B, the communication coil 1002 may be located at an innermost position, the reception coil 1003 may be located in the middle, and the pickup coil 1001 may be located at an outermost position, but the present disclosure is not limited thereto. Referring to 210 of FIG. 2C, the reception coil 1003 may be located at an innermost position, the pickup coil 1001 may be located in the middle, and the communication coil 1002 may be located at an outermost position. Referring to 220 of FIG. 2C, the reception coil 1003 may be located at an innermost position, the communication coil 1002 may be located in the middle, and the pickup coil 1001 may be located at an outermost position. Although not shown, the coils may be arranged in the following order from an innermost position.
1) the pick-up coil 1001—the reception coil 1003—the communication coil 1002
2) the pick-up coil 1001—the communication coil 1002—the reception coil 1003
3) the communication coil 1002—the pickup coil 1001—the reception coil 1003

According to an embodiment of the present disclosure, in the 2-2 type cooking device 1000b-2, the pickup coil 1001, the communication coil 1002, and the reception coil 1003 may be arranged in a stacked structure. For example, referring to 230 of FIG. 2C, the pickup coil 1001 and the communication coil 1002 which do not have many turns form one layer, and the reception coil 1003 forms another layer, and thus, two layers may be stacked.

The load 1004 may include, but is not limited to, a heater, a motor, or a battery to be charged. The heater is for heating the contents in the 2-2 type cooking device 1000b-2. The heater may have any of various shapes, and an outer cover of the heater may include any of various materials (e.g., iron, stainless steel, copper, aluminum, encoloy, or incotel). According to an embodiment of the present disclosure, the 2-2 type cooking device 1000b-2 may include a plurality of heaters. For example, the 2-2 type cooking device 1000b-2 may include a warming heater and a heating heater. The warming heater and the heating heater may produce different levels of heating output. For example, a heating level of the warming heater may be lower than a heating level of the heating heater.

According to an embodiment of the present disclosure, the 2-2 type cooking device 1000b-2 may further include a resonance capacitor (not shown) between the reception coil 1003 and the load 1004. In this case, a resonance value may be set to vary according to the amount of power required by the load 1004. According to an embodiment of the present disclosure, the 2-2 type cooking device 1000b-2 may further include a switch unit (e.g., a relay switch or a semiconductor switch) (not shown) for turning on/off an operation of the load 1004.

According to an embodiment of the present disclosure, examples of the 2-2 type cooking device 1000b-2 may include, but are not limited to, a heater-applied product (e.g., a coffee machine (coffee dripper), or a toaster) and a motor-applied product (e.g., a blender).

According to an embodiment of the present disclosure, because the first type cooking device 1000a includes the IH metal, the first type cooking device 1000a may be detected in an IH container detection mode of the electromagnetic induction device 2000. However, because the first type cooking device 1000a may not communicate with the electromagnetic induction device 2000, the first type cooking device 1000a may not be detected in a small appliance detection mode of the electromagnetic induction device 2000. Because the 2-1 type cooking device 1000b-1 includes the IH metal, the 2-1 type cooking device 1000b-1 may be detected in the IH container detection mode of the electromagnetic induction device 2000, and because the 2-1 type cooking device 1000b-1 may communicate with the electromagnetic induction device 2000, the 2-1 type cooking device 1000b-1 may also be detected in the small appliance detection mode of the electromagnetic induction device 2000. Because the 2-2 type cooking device 1000b-2 does not include the IH metal, the 2-2 type cooking device 1000b-2 is not detected in the IH container detection mode. However, because the 2-2 type cooking device 1000b-2 may communicate with the electromagnetic induction device 2000, the 2-2 type cooking device 1000b-2 may be detected in the small appliance detection mode of the electromagnetic induction device 2000.

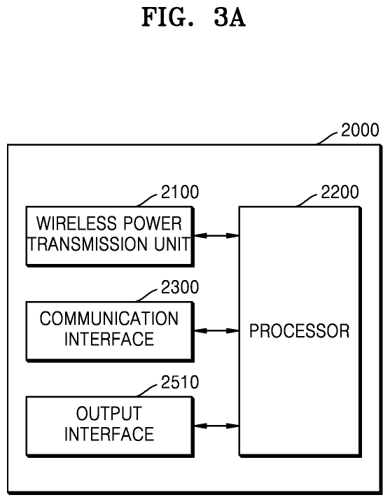

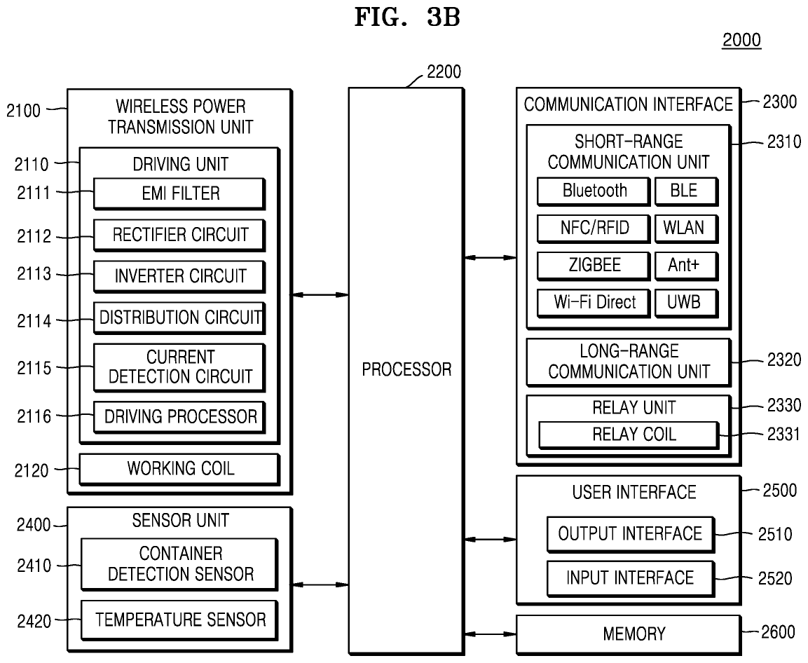

Hereinafter, the electromagnetic induction device 2000 for transmitting power to the first or second type cooking device 1000a or 1000b will be described in detail with reference to FIGS. 3A, 3B, and 4.

FIGS. 3A and 3B are block diagrams for describing a function of an electromagnetic induction device, according to an embodiment of the present disclosure.

As shown in FIG. 3A, the electromagnetic induction device 2000 according to an embodiment of the present disclosure may include a wireless power transmission unit 2100, a processor 2200, a communication interface 2300, and an output interface 2510. However, not all of the illustrated elements are essential elements. The electromagnetic induction device 2000 may include more elements or fewer elements than the illustrated elements. As shown in FIG. 3B, the electromagnetic induction device 2000 according to an embodiment of the present disclosure may include the wireless power transmission unit 2100, the processor 2200, the communication interface 2300, a sensor unit 2400, a user interface 2500, and a memory 2600.

Hereinafter, the elements will be sequentially described.

The wireless power transmission unit 2100 may include a driving unit 2110 and the working coil 2120, but is not limited thereto. The driving unit 2110 may receive power from an external source and supply current to the working coil 2120 according to a driving control signal of the processor 2200. The working coil may be referred to as an induction coil or an electromagnetic induction coil. The driving unit 2110 may include an electromagnetic interference (EMI) filter 2111, a rectifier circuit 2112, an inverter circuit 2113, a distribution circuit 2114, a current detection circuit 2115, and a driving processor 2116, but is not limited thereto.

The EMI filter 2111 may block high-frequency noise included in alternating current power supplied from an external source, and may pass an alternating current voltage and alternating current of a pre-determined frequency (e.g., 50 Hz or 60 Hz). A fuse and a relay for blocking overcurrent may be provided between the EMI filter 2111 and the external source. Alternating current power from which high-frequency noise is blocked by the EMI filter 2111 is supplied to the rectifier circuit 2112.

The rectifier circuit 2112 may convert alternating current power into direct current power. For example, the rectifier circuit 2112 may convert an alternating current voltage whose magnitude and polarity (positive voltage or negative voltage) change with time into a direct current voltage whose magnitude and polarity are constant, and may convert alternating current whose magnitude and direction (positive current or negative current) change with time into direct current whose magnitude is constant. The rectifier circuit 2112 may include a bridge diode. For example, the rectifier circuit 2112 may include four diodes. The bridge diode may convert an alternating current voltage whose polarity changes with time into a positive voltage whose polarity is constant, and convert alternating current whose direction changes with time into positive current whose direction is constant. The rectifier circuit 2112 may include a direct current (DC) link capacitor. The DC link capacitor may convert a positive voltage whose magnitude changes with time into a direct current voltage whose magnitude is constant.

The inverter circuit 2113 may include a switching circuit for supplying or blocking driving current to the working coil 2120, and a resonance circuit for causing resonance with the working coil 2120. The switching circuit may include a first switch and a second switch. The first switch and the second switch may be connected in series between a plus line and a minus line output from the rectifier circuit 2112. The first switch and the second switch may be turned on or off according to a driving control signal of the driving processor 2116.

The inverter circuit 2113 may control current supplied to the working coil 2120. For example, a magnitude and a direction of current flowing through the working coil 2120 may vary according to turning on/off of the first switch and the second switch included in the inverter circuit 2113. In this case, alternating current may be supplied to the working coil 2120. Alternating current in a sine wave form is supplied to the working coil 2120 according to a switching operation of the first switch and the second switch. Also, as a switching period of the first switch and the second switch increases (e.g., as a switching frequency of the first switch and the second switch decreases), current supplied to the working coil 2120 may increase, and an intensity of a magnetic field (output of the electromagnetic induction device 2000) output from the working coil 2120 may increase.

When the electromagnetic induction device 2000 includes a plurality of working coils 2120, the driving unit 2110 may include a distribution circuit 2114. The distribution circuit 2114 may include a plurality of switches that pass or block current supplied to the plurality of working coils 2120, and the plurality of switches may be turned on or off according to a distribution control signal of the drive processor 2116.

The current detection circuit 2115 may include a current sensor that measures current output from the inverter circuit 2113. The current sensor may transmit an electrical signal corresponding to the measured current value to the driving processor 2116.

The driving processor 2116 may determine a switching frequency (turn on/off frequency) of the switching circuit included in the inverter circuit 2113 based on an output intensity (power level) of the electromagnetic induction device 2000. The driving processor 2116 may generate a driving control signal for turning on/off the switching circuit according to the determined switching frequency.

The working coil 2120 may generate a magnetic field for heating the cooking device 1000. For example, when driving current is supplied to the working coil 2120, a magnetic field may be induced around the working coil 2120. When current, that is, alternating current, whose magnitude and direction change with time is supplied to the working coil 2120, a magnetic field whose magnitude and direction change with time may be induced around the working coil 2120. The magnetic field around the working coil 2120 may pass through a top plate formed of tempered glass and may reach the cooking device 1000 placed on the top plate. Due to the magnetic field whose magnitude and direction change with time, eddy current rotating around the magnetic field may be generated in the cooking device 1000, and electrical resistance heat may be generated in the cooking device 1000 due to the eddy current. The electrical resistance heat is heat generated in a resistor when current flows through the resistor, and is also referred to as Joule heat.

The cooking device 1000 may be heated by the electrical resistance heat, and the contents in the cooking device 1000 may be heated. Meanwhile, when the cooking device 1000 is the 2-2 type cooking device 1000b-2 including the reception coil 1003 (see FIG. 2), the magnetic field around the working coil 2120 may be induced in the reception coil 1003.

The processor 2200 controls an overall operation of the electromagnetic induction device 2000. The processor 2200 may control the wireless power transmission unit 2100, the communication interface 2300, the sensor unit 2400, the user interface 2500, and the memory 2600 by executing programs stored in a memory 2600.

According to an embodiment of the present disclosure, the electromagnetic induction device 2000 may include an artificial intelligence (AI) processor. The AI processor may be manufactured in the form of a dedicated hardware chip for AI, or may be manufactured as a part of an existing general-purpose processor (e.g., a central processing unit (CPU) or an application processor) or a dedicated graphic processor (e.g., a graphics processing unit (GPU)) and mounted on the electromagnetic induction device 2000.

According to an embodiment of the present disclosure, the processor 2200 may control the inverter circuit 2113 to supply power of a preset level to the cooking device 1000 to drive the communication interface 1030 of the cooking device 1000, and when the communication interface 1030 of the cooking device 1000 is driven, may receive a first wireless communication signal transmitted from the communication interface 1030 of the cooking device 1000.

When the first wireless communication signal transmitted from the cooking device 1000 is detected, the processor 2200 may control the inverter circuit 2113 to enable a plurality of working coils 2120 to generate magnetic fields according to a plurality of different power transmission patterns. The plurality of power transmission patterns may be set differently based on at least one of a duration of a power transmission interval, a duration of a power cut-off interval, and a power level. For example, the processor 2200 may control the inverter circuit 2113 to transmit power by differently combining the duration of the power transmission interval, the duration the power cut-off interval, and the power level for each cooking zone.

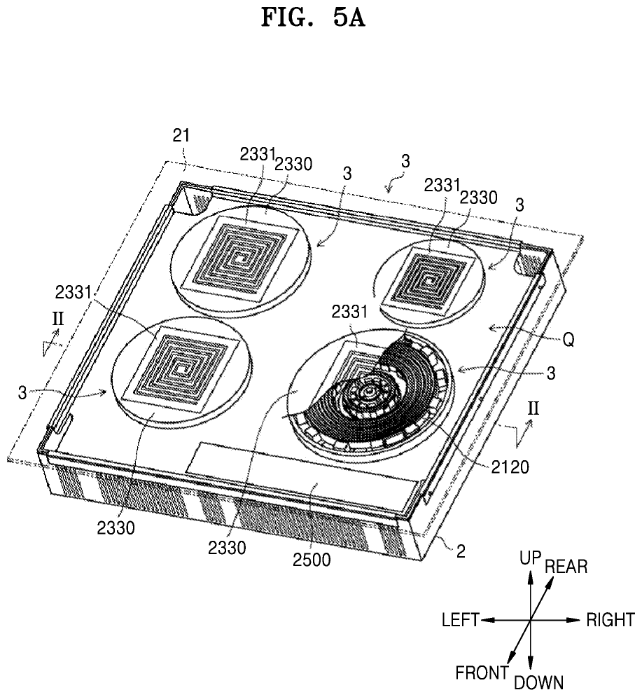

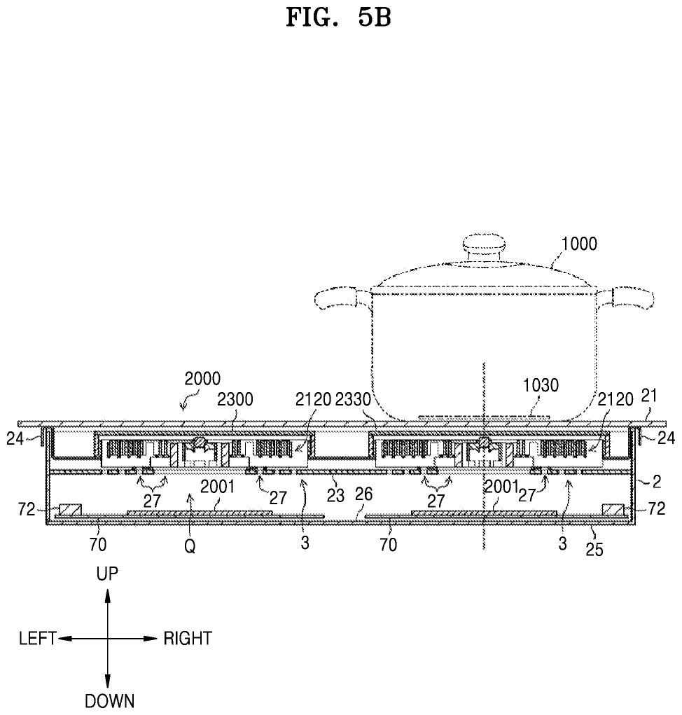

Also, the processor 2200 may receive, from the cooking device 1000 through the communication interface 1300, a second wireless communication signal including information about a first cooking zone corresponding to a first power transmission pattern detected at a position of the cooking device 1000 from among the plurality of power transmission patterns and identification information of the cooking device 1000, and may output, through the output interface 2510, the information about the first cooking zone in which the cooking device 1000 is located from among the plurality of cooking zones and the identification information of the cooking device 1000, based on the second wireless communication signal. A method by which the electromagnetic induction device 2000 identifies a cooking zone in which the cooking device 1000 is located by using a plurality of power transmission patterns will be described below in detail with reference to FIG. 5.

According to an embodiment of the present disclosure, when the processor 2200 does not receive a first wireless communication signal from the cooking device 1000 within a certain time after detecting that the cooking device 1000 is located on the top plate of the electromagnetic induction device 2000, the processor 2200 may identify the cooking device 1000 as the first type cooking device 1000a that is a general induction heating container. When the processor 2200 detects the first wireless communication signal transmitted from the communication interface 1030 of the cooking device 1000, the processor 2200 may identify the cooking device 1000 as the second type cooking device 1000b capable of communication.

According to an embodiment of the present disclosure, the processor 2200 may control the inverter circuit 2113 to establish communication connection with the cooking device based on communication connection information included in the second wireless communication signal, and transmit power of a first level (low power) for maintaining the communication connection with the cooking device 1000 to the pickup coil 1001 of the cooking device 1000. Also, when an operation command for the cooking device 100 is received from a user, the processor 2200 may control the inverter circuit 2113 to transmit power of a second level (high power) for operating the cooking device 1000 to the cooking device 1000. In this case, the power of the first level is less than the power of the second level.

The communication interface 2300 may include one or more elements for communication between the electromagnetic induction device 2000 and the cooking device 1000 or between the electromagnetic induction device 2000 and a server device. For example, the communication interface 2300 may include a short-range communication unit 2310, a long-range communication unit 2320, and a relay unit 2330. Examples of the short-range communication unit 2310 may include, but are not limited to, a Bluetooth communication unit, a Bluetooth low energy (BLE) communication unit, a near-field communication (NFC) unit, a wireless local area network (WLAN) (Wi-Fi) communication unit, a Zigbee communication unit, an infrared data association (IrDA) communication unit, a Wi-Fi direct (WFD) communication unit, an ultra-wideband (UWB) communication unit, and an Ant+ communication unit. The long-range communication unit 2320 may be used to communicate with the server device when the cooking device is remotely controlled by the server device (not shown) in an Internet of Things (IoT) environment. Examples of the long-range communication unit 2320 may include the Internet, a computer network (e.g., LAN or WAN), and a mobile communication unit. The mobile communication unit transmits and receives a wireless signal to and from at least one of a base station, an external terminal, and a server, on a mobile communication network. Here, the wireless signal may include a voice call signal, a video call signal, or various types of data according to text/multimedia message transmission/reception. Examples of the mobile communication unit may include, but are not limited to, a 3G module, a 4G module, an LTE module, a 5G module, a 6G module, an NB-IoT module, and an LTE-M module.

The relay unit 2330 relays a signal between the communication interface 2300 and an external device.

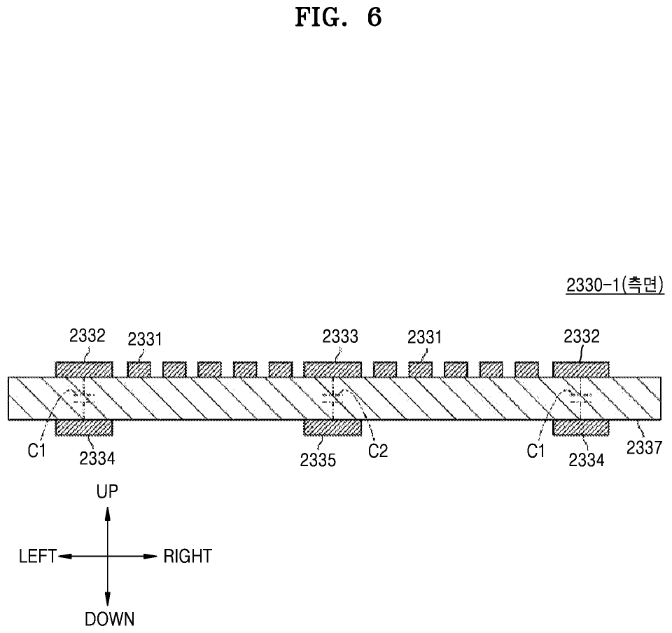

The relay unit 2330 includes a relay circuit 2339, and the relay circuit 2339 may include a relay coil 2331. A detailed configuration of the relay circuit and a detailed description thereof will be described below with reference to FIGS. 6 to 11.

According to another embodiment of the present disclosure, the relay unit 2330 may be configured as a block separate from the communication interface 2300, rather than a block in the communication interface 2300.

The sensor unit 2400 may include a container detection sensor 2410 and a temperature sensor 2420, but is not limited thereto.

The container detection sensor 2410 may be a sensor for detecting that the cooking device 1000 is placed on the top plate. For example, the container detection sensor 2410 may be implemented as, but not limited to, a current sensor. The container sensor 2410 may be implemented as at least one of a proximity sensor, a touch sensor, a weight sensor, a temperature sensor, an illuminance sensor, and a magnetic sensor.

The temperature sensor 2420 may detect a temperature of the cooking device 1000 placed on the top plate or a temperature of the top plate. The cooking device 1000 may be induction heated by the working coil 2120 and may be overheated according to a material. Accordingly, the electromagnetic induction device 2000 may detect a temperature of the cooking device 1000 placed on the top plate or a temperature of the top plate, and, when the cooking device 1000 is overheated, may block an operation of the working coil 2120. The temperature sensor 2420 may be provided near the working coil 2120. For example, the temperature sensor 2420 may be located at the center of the working coil 2120.

According to an embodiment of the present disclosure, the temperature sensor 2420 may include a thermistor whose electrical resistance value changes according to a temperature. For example, the temperature sensor may be a negative temperature coefficient (NTC) temperature sensor, but is not limited thereto. The temperature sensor may be a positive temperature coefficient (PTC) temperature sensor.

The user interface 2500 may include an output interface 2510 and an input interface 2520. The output interface 2510 for outputting an audio signal or a video signal, may include a display unit and a sound output unit.

When the display unit and a touch pad have a layer structure to form a touch screen, the display unit may be used as the input interface in addition to the output interface. The display unit may include at least one of a liquid crystal display, a thin-film transistor-liquid crystal display, a light-emitting diode (LED), an organic light-emitting diode, a flexible display, a three-dimensional (3D) display, and an electrophoretic display. According to an implementation form of the electromagnetic induction device 2000, the electromagnetic induction device 2000 may include two or more display units.

The sound output unit may output audio data received from the communication interface 2300 or stored in the memory 2600. Also, the sound output unit may output a sound signal related to a function performed by the electromagnetic induction device 2000. The sound output unit may include a speaker or a buzzer.

According to an embodiment of the present disclosure, the output interface 2510 may display information about the cooking device. For example, the output interface 2510 may output a graphical user interface (GUI) corresponding to identification information of the cooking device 1000.

According to an embodiment of the present disclosure, when the processor 2200 does not receive information about a cooking zone in which the cooking device 1000 is located within a certain time after the processor 2200 controls the inverter circuit 2113 to enable a plurality of working coils 2020 to generate magnetic fields according to a plurality of different power transmission patterns, the output interface 2510 may output a notification to check a position of the cooking device 1000. Also, according to an embodiment of the present disclosure, as the communication connection with the cooking device 1000 is removed, the output interface 2510 may output a notification to check a position of the cooking device 1000.

The input interface 2520 is for receiving input from the user. The input interface 2520 may be at least one of, but not limited to, a key pad, a dome switch, a touch pad (e.g., contact capacitance type, pressure resistive type, infrared (IR) detection type, surface ultrasonic wave conduction type, integral tension measuring type, or piezoelectric effect type), a jog wheel, and a jog switch.

The input interface 2520 may include a voice recognition module. For example, the electromagnetic induction device 2000 may receive a voice signal, which is an analog signal, through a microphone and convert the voice part into computer-readable text by using an automatic speech recognition (ASR) model. The electromagnetic induction device 2000 may interpret the converted text by using a natural language understanding (NLU) model to obtain the user's utterance intention. Here, the ASR model or the NLU model may be an AI model. The AI model may be processed by an AI processor designed as a hardware structure specialized in processing an AI model. The AI model may be created through learning. Here, “created through learning” means that, as a basic AI model is trained by using a plurality of pieces of training data according to a learning algorithm, a pre-defined operation rule or AI model set to perform desired characteristics (or purposes) is created. The AI model may include a plurality of neural network layers. The plurality of neural network layers have a plurality of weight values, and a neural network operation is performed through an operation between an operation result of a previous layer and the plurality of weight values.

Linguistic understanding is a technology for recognizing and applying/processing human languages/characters, and includes natural language processing, machine translation, dialog systems, question answering, and voice recognition/synthesis.

The memory 2600 may store a program for processing and control of the processor 2200 or may store input/output data (e.g., a plurality of power transmission patterns). The memory 2600 may store an AI model.

The memory 2600 may include at least one type of storage medium of a flash memory type storage unit, a hard disk type storage unit, a multimedia card micro type storage unit, a card type memory (e.g., an SD or XD memory), a random-access memory (RAM), a static random-access memory (SRAM), a read-only memory (ROM), an electrically erasable programmable read-only memory (EEPROM), a programmable read-only memory (PROM), a magnetic memory, a magnetic disk, and an optical disk. Also, the electromagnetic induction device 2000 may operate a web storage or cloud server that performs a storage function on the Internet.

FIG. 4 is a view for describing a wireless power transmission unit of an electromagnetic induction device (wireless power transmission device) according to an embodiment of the present disclosure.

Referring to FIG. 4, the electromagnetic induction device 2000 may further include a communication coil 2001 on the same layer as a transmission coil (working coil or induction coil 2120). In this case, the communication coil 2001 may be an NFC antenna coil for NFC communication. Although the number of turns of the communication coil 2001 is one in FIG. 4, the present disclosure is not limited thereto. The number of turns of the communication coil 2001 may be plural. For example, the communication coil 2001 may be wound 5 to 6 times.

According to an embodiment of the present disclosure, the communication coil 2001 included in the electromagnetic induction device 2000 and the communication coil 1002 included in the cooking device 1000 may be located at positions corresponding to each other. For example, when the communication coil 2001 included in the electromagnetic induction device 2000 is located at the center of each cooking zone, the communication coil 1002 included in the cooking device 1000 may also be located at the center of a bottom surface of the cooking device 1000.

Referring to 410 of FIG. 4, when the 2-1 type cooking device 1000b-1 is placed on the electromagnetic induction device 2000, the electromagnetic induction device 2000 may supply power to the pickup coil 1001 through the transmission coil 2120. Also, when the electromagnetic induction device 2000 wirelessly transmits power through the transmission coil 2120, eddy current may be generated in the 2-1 type cooking device 1000b-1 to heat the contents in the 2-1 type cooking device 1000b-1.

Referring to 420 of FIG. 4, when the 2-2 type cooking device 1000b-2 is placed on the electromagnetic induction device 2000, the electromagnetic induction device 2000 may supply power to the pickup coil 1001 through the transmission coil 2120. Also, when the electromagnetic induction device 2000 wirelessly transmits power through the transmission coil 2120, induced current flows through the reception coil 1003 of the 2-2 type cooking device 1000b-2 to supply energy to the load 1004. The load 1004 may include a motor or a heater, and the load 1004 may be located at a position spaced apart from the reception coil 1003. For example, the power generated by the induced current may drive a motor of a blender or may supply energy to a heater of a coffee dripper.

Although the electromagnetic induction device 2000 includes the communication coil 2001 in FIG. 4, the electromagnetic induction device 2000 may not include the communication coil 2001 when the cooking device 1000 does not include the communication coil 1002 (see FIG. 2A).

FIG. 5A is a perspective view of an electromagnetic induction device, according to an embodiment of the present disclosure. FIG. 5B is a cross-sectional view of an electromagnetic induction device, according to an embodiment of the present disclosure.

Referring to FIG. 5A, the electromagnetic induction device 2000 according to an embodiment of the present disclosure may be an IH cooking heater as an induction heating device, and a front side in a direction a user is facing is referred to as “front” and an inner side is referred to as “rear”, a left side when viewed inward from the front side is referred to as “left” and a right side is referred to as “right”, and an upper side in a height direction at the time of use is referred to as “up” and a lower side is referred to as “down”.

As shown in FIG. 5A, the electromagnetic induction device 2000 according to an embodiment of the present disclosure is an induction heating device, and a so-called built-in IH cooking heater assembled in a built-in opening (not shown) provided in a kitchen countertop is illustrated. The induction heating device is configured to heat the cooking device 1000, such as a frying pan or a pot, by using the principle of electromagnetic induction.

Also, the electromagnetic induction device 2000 according to an embodiment of the present disclosure is not limited to a built-in IH cooking heater, and for example, the electromagnetic induction device 2000 may be configured so that the working coil (or induction coil) 2120 is directly embedded in furniture such as a table or cooking equipment installed in a building.

Also, the cooking device 1000 is not limited to a frying pan or a pot, and may be an electric device in which the reception coil 1003 for receiving wireless power from the working coil 2120 is embedded.

The IH cooking heater, which is the electromagnetic induction device 2000, includes a top plate 21 located directly over the working coil 2120, and an insulator sheet (e.g., a mica sheet) to prevent a user from electric shock when glass is damaged. In this case, because a distance between the insulator sheet and the top plate 21 is 1 mm or less, which is very close, when a control circuit is located under the working coil 2120, the communication performance of the electromagnetic induction device 2000 may be degraded due to the influence of the insulator sheet. In particular, in the case of contactless short-range communication (e.g., NFC or RFID), a communication failure may occur due to the insulator sheet.

In order to solve this problem, the electromagnetic induction device 2000 according to an embodiment of the present disclosure may include a resonance circuit in an insulating dielectric sheet located between the top plate 21 and the working coil 2120. According to an embodiment of the present disclosure, a thin antenna may be implemented by forming an electrode portion and a coil portion formed of a conductor (e.g., conductive ink) on the insulating dielectric sheet.

An antenna according to an embodiment of the present disclosure may be located on the working coil 2120 and insulation performance may be maintained because a mechanical contact such as a connector is not required. Also, the antenna according to an embodiment of the present disclosure may include a capacitor configured using an electrode of a dielectric, a resonance frequency may be adjusted by adjusting a dielectric constant of the dielectric.

The electromagnetic induction device 2000 shown in FIG. 5A is a four-hole type induction heating device having four heating units 3 on which the cooking device 1000 capable of induction heating is to be placed. The four heating units 3 may be arranged at certain intervals. When the electromagnetic induction device 2000 is viewed from above, the four heating units 3 may be arranged to have a substantially quadrangular shape when centers of the heating units 3 are connected. Referring to FIGS. 5A and 5B, the electromagnetic induction device 2000 includes a case 2 on which the top plate 21 is provided, at least one heating unit 3, the relay unit 2330 provided for each heating unit 3, the user interface 2500, and a control board 70, and the at least one heating unit 3, at least one relay unit 2330 provided for each heating unit 3, the user interface 2500, and the control substrate 70 are accommodated in the case 2. The case 2 has an outer surface corresponding to a space in which the electromagnetic induction device 2000 is installed, and the case 2 is formed in a rectangular hexahedral shape that is open upward and is mainly formed of a sheet metal. An edge-shaped bracket 24 is assembled around the opening of the case 2. The top plate 21 is provided on the bracket 24 to cover the opening of the case 2, and thus, a receiving space Q is formed in the case on which the top plate 21 is located. A middle plate 23 for installing the heating unit 3 is provided at an intermediate position in an up-down direction, in the receiving space Q. A ventilation hole 27 for cooling the working coil 2120 is formed at a position corresponding to the working coil 2120 in the middle plate 23.

When the electromagnetic induction device 2000 according to an embodiment of the present disclosure does not include the case 2 (not shown), the working coil 2120 may be directly embedded in furniture such as a table or cooking equipment installed in a building, the receiving space Q may be formed in the furniture or the cooking equipment, and the working coil 2120 may be accommodated in the receiving space Q.

The user interface 2500 may be provided in a panel shape on a front surface of the top plate 21. The user interface 2500 may display a heating level for the cooking device 1000 placed on the top plate 21 through the output interface 2510, and may obtain an input of the user through the input interface 2520. The user interface 2500 may include a display unit including, for example, a liquid crystal display device, and a touch panel, and manipulation and display types of the user interface 2500 are not particularly limited and may be implemented in various ways.

The heating unit 3 includes the working coil 2120 supported by a disk-shaped coil base provided on the middle plate 23. The working coil 2120 may be, for example, a balance coil radially wound along the top plate 21. The working coil 2120 may be driven by the driving unit 2110, and may generate a magnetic flux in a direction (up-down direction) toward the top plate 21, that is, toward the cooking device 1000 placed on the top plate 21. Accordingly, the electromagnetic induction device 2000 may induction heat the cooking device 1000 placed on the top plate 21 or supply power to the cooking device 1000 by using a working coil (not shown) included in the cooking device 1000. A driving frequency (the frequency of driving current) of the working coil 2120 may be determined to be tens of kHz.

The working coil 2120 is not limited to a balance coil. For example, at a position corresponding to the working coil 2020 of FIG. 5A, the working coil 2120 wound around a ferrite core or the like extending along the top plate 21 may be provided in parallel in a front-rear direction or a left-right direction. Also, the working coils 2120 of the one or more heating units 3 may have the same configuration or different configurations according to the heating units 3.

The control board 70 may be provided for each heating unit 3 and may be located under each heating unit 3. Referring to FIG. 5B, in the electromagnetic induction device 2000 according to an embodiment of the present disclosure, the control board 70 may be provided on a bottom plate of the case 2, that is, on a bottom surface 26 of the receiving space Q. The control board 70 may include the communication coil 2001 for wireless data communication with the communication interface 1030 included in the cooking device 1000, and a control circuit 72.

The control circuit 72 of the electromagnetic induction device 2000 may include the driving unit 2110 for driving the working coil 2120 based on a user input obtained by the user interface 2500, and a communication circuit 2311 for wireless communication with the communication interface 1030 of the cooking device 1000 through the communication coil 2001. The communication interface 1030 of the cooking device 1000 may include the communication coil 1002 and a communication circuit 1032 wirelessly communicating with the communication circuit 2311 through the communication coil 1002. However, a configuration of the communication interface 1030 of the cooking device 1000 is not limited thereto.

Data transmitted and received through wireless communication is not limited. For example, setting data such as a set temperature may be transmitted from the electromagnetic induction device 2000 to the cooking device 1000, required power amount data may be transmitted from the cooking device 1000 to the electromagnetic induction device 2000, or a measured temperature of a medium (e.g., food) accommodated in the cooking device 1000 may be transmitted.

The communication coil 2001 outputs a carrier wave having a frequency different from a driving frequency of the working coil 2120 for wireless communication. A frequency of a carrier wave may be determined in various ways. For example, when a communication method based on a near field communication (NFC) standard (hereinafter, referred to as NFC) is used for communication between the cooking device 1000 and the control circuit 72, a frequency of a carrier wave may be set to 13.56 [MHz]. The communication coil 2001 may be provided directly under the working coil 2120, and generally, the electromagnetic induction device 2000 is configured so that the cooking device 1000 is provided directly over the working coil 2120. Accordingly, when the communication coil 2001 is provided directly under the working coil 2120, the user does not need to align the cooking device 1000 with the communication coil 2001.

Referring to FIG. 5B, the relay unit 2330 may be located between the top plate 21 of the case 2 and the working coil 2120. The relay unit 2330 may include a plate-like or sheet-like dielectric (not shown) extending along the top plate 21. The relay coil 2331 may be formed on a surface of the dielectric. The relay coil 2331 may be formed on a top surface or a bottom surface of the dielectric.

The dielectric may have a circular shape equal to or slightly larger than an outer diameter of a coil base (not shown), and may be located on a peripheral portion of the coil base (not shown). In this case, when the top plate 21 is formed of a material such as glass, the working coil 2120 is not exposed even when the top plate 21 is damaged, thereby preventing the user from contacting the working coil 2120.

A material of the dielectric is not particularly limited. For example, mica (εr=7.0 or εr=7.5) may be used as a material of the dielectric. Because a material having a high relative permittivity such as mica is used, a thickness or an electrode area for ensuring an inter-line capacitance (C1 or C2) described below may be reduced. Also, a material of the dielectric is not limited to mica, and another material having a relative permittivity equal to or greater than that of mica may be used.

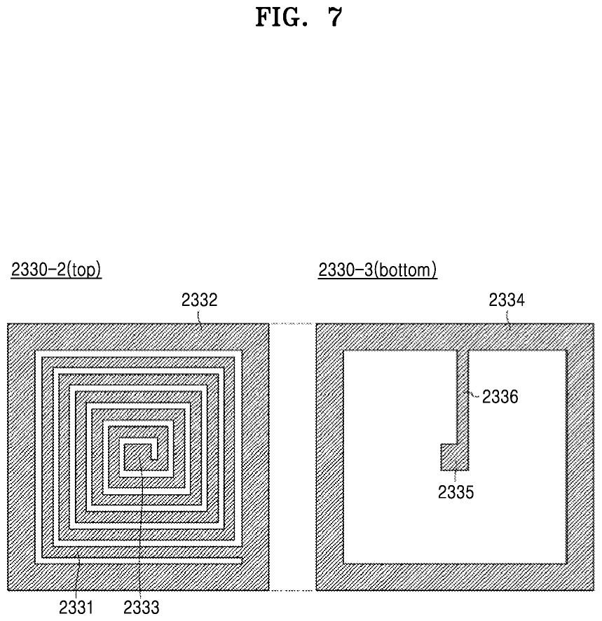

FIG. 6 is a side view illustrating a configuration of a relay unit, according to an embodiment of the present disclosure. FIG. 7 is a top view or bottom view of a relay unit, according to an embodiment of the present disclosure.

Referring to FIGS. 6 and 7, the relay coil 2331 may be a planar coil in which a conductive line is formed to have a rectangular spiral shape with a plurality of turns on a sheet-like dielectric 2337, and it is noted that the dielectric is omitted in FIG. 7.

A material of the conductive line is not particularly limited, but it is preferable to have a low resistivity. For example, conductive ink, a conductive tape, a conductive substrate, or the like, formed of a metal material such as copper, may be used as the conductive line. Also, the shape of the relay coil 2331 is not limited to a rectangular spiral shape, and may have a different shape, for example, a circular spiral shape.

Referring to 2330-1 of FIG. 6, a surface outer electrode 2332 connected to an outer surface of the relay coil 2331 and surrounding the relay coil 2331 and a surface inner electrode 2333 connected to an inner surface (opposite surface) of the relay coil 2331 may be formed on a surface of the dielectric 2337. A center position of the relay coil 2331 may be determined based on a center position of the communication coil 2001, and the relay coil 2331 may efficiently receive a magnetic flux output from the communication coil 2001 by matching the center positions of the communication coil 2001 and the relay coil 2331.

Further, a rear outer electrode 2334 formed to face the surface outer electrode 2332 and a rear inner electrode 2335 formed to face the surface inner electrode 2333 are provided on a rear surface of the dielectric 2337. Accordingly, an inter-line capacitance C1 may be formed between the surface outer electrode 2332 and the rear outer electrode 2334, and an inter-line capacitance C2 may be formed between the surface inner electrode 2333 and the rear inner electrode 2335.

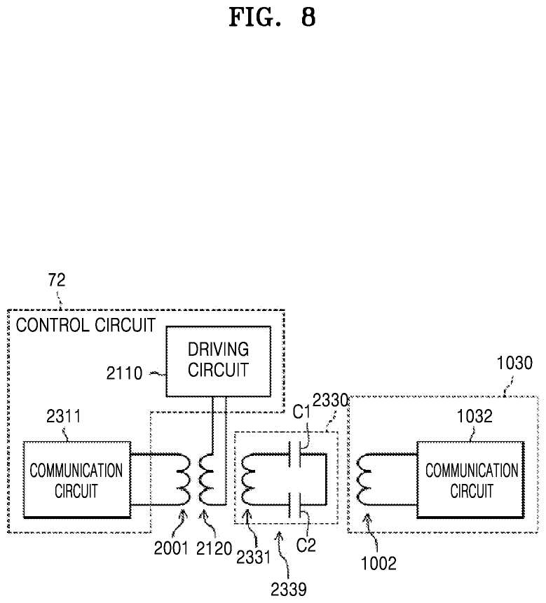

Referring to 2330-3 of FIG. 7, the rear outer electrode 2334 and the rear inner electrode 2335 are connected to each other via a connection line 2336 extending to be orthogonal to the conductive line constituting the relay coil 2331. Accordingly, as shown in FIG. 8, the relay unit 2330 may include the relay circuit 2339, which is a series resonance circuit in which the relay coil 2331, the inter-line capacitance C1, and the inter-line capacitance C2 are connected in series.

FIG. 8 is an equivalent circuit diagram illustrating an electromagnetic induction system including a relay unit, according to an embodiment of the present disclosure.

Because the relay circuit 2339 resonates at a carrier frequency of a carrier wave output from the communication coil 2001, even when the carrier wave output from the communication coil 2001 is inhibited by the working coil (or induction coil) 2120, the relay unit 2330 may amplify a leakage flux from the communication coil 2001. Also, because the communication coil 1002 of the cooking device 1000 and the relay coil 2331 are be magnetically coupled to each other, a carrier wave output from the communication coil 2001 may be transmitted to the communication circuit 1032 of the cooking device 1000.

Referring to FIG. 8, a resonance frequency (fo) of the relay circuit 2339 is defined by Equation 1 below.

ƒ₀=½π\sqrt{LC} [Equation 1]

In this case, L is an inductance of the relay coil 2331, C is a combined capacitance of the inter-line capacitance C1 and the inter-line capacitance C2, and C is defined by Equation 2.

C=ε₀ε_{z}s/d [Equation 2]

In this case, ε_s is a relative permeability of the dielectric 2337, d is a thickness of the dielectric 2337, and S is a surface area of a counter electrode.

For example, when mica having a thickness of 0.3 mm (εr=7.0) is used as a dielectric, a surface area of a counter electrode of the surface and rear outer electrodes 2332 and 2334 formed on the surface of the dielectric 2337 is 3420 [mm²], and a surface area of a counter electrode of the surface and rear inner electrodes 2333 and 2335 is 625 [mm²], the combined capacitance C of the series connection determined according to Equation 2 is about 100 [pF].

When the inductance L of the relay coil 2331 is 1.3 [pF], a resonance frequency of the relay circuit 2339 may be about 13.56 [MHz] according to Equation 1. That is, the relay circuit 2339 of the relay unit 2330 is configured to resonate at a carrier frequency of an NFC carrier wave.

Also, the inductance L of the relay coil 2331 may be adjusted by changing a diameter of the coil or the number of turns of the coil. For example, the capacitance C1 or the inter-line capacitance C2 may be adjusted by adjusting a relative permittivity of a material used as the dielectric 2337 or a thickness of the dielectric 2337. Also, the inter-line capacitance C1 or the inter-line capacitance C2 may be adjusted by changing, for example, a facing surface area of an electrode formed on a surface of the dielectric 2337.

In other words, the resonance frequency (fo) may be set to an arbitrary value by changing a design of one or more of the inductance L of the relay coil 2331, the inter-line capacitance C1, or the inter-line capacitance C2. As described above, a resonance frequency may be flexibly changed even for communication standards having different carrier frequencies such as RFID by changing a configuration of the relay unit 2330 according to an embodiment of the present disclosure.

In summary, the electromagnetic induction device 2000 according to an embodiment of the present disclosure may include the case 2 on which the top plate 21 is provided, the working coil 2120, the communication coil 2001, and the relay unit 2330. The working coil 2120 is provided in the receiving space Q in the case 2, and generates a magnetic flux in a direction toward the cooking device 1000 located on the top plate 21. The communication coil 2001 is provided between a bottom plate 25 of the case 2 and the working coil 2120, and outputs a carrier electromagnetic wave having a frequency different from a driving frequency of the working coil 2120 in a direction toward the top plate 21. The relay unit 2330 includes the relay coil 2331 provided between the top plate 21 and the working coil 2120 to be magnetically coupled to the communication coil 2001, and the relay circuit 2339 that is a series resonance circuit including capacitors having the inter-line capacitances C1 and C2.

In this configuration, as described above, even when a carrier wave output from the communication coil 2001 is inhibited by the working coil 2120, the relay unit 2330 may amplify a leakage flux from the communication coil 2001. Also, because the communication coil 1002 of the cooking device 1000 and the relay coil 2331 are magnetically coupled to each other, a carrier wave output from the communication coil 2001 may be transmitted to the communication circuit 1032 of the cooking device 1000. That is, even when the working coil 2120 is located between the communication coil 2001 and the cooking device 1000, data communication may be performed between the control circuit 72 and the cooking device 1000 through the communication coil 2001.

According to an embodiment of the present disclosure, the relay coil 2331 may be formed on a surface of a plate-like or sheet-like dielectric. As described above, because the relay coil 2331 is formed on the surface of the plate-like or sheet-like dielectric 2337 and inserted between the top plate 21 and the working coil 2120, the safety of a user may be ensured even when the top plate 21 is damaged.

Also, because the relay coil 2331 is formed on the surface of the plate-like or sheet-like dielectric 2337, a thickness of the relay unit 2330 may be reduced and a decrease in heating efficiency or power supply efficiency may be prevented. Furthermore, manufacturing costs may be reduced compared to a method of embedding an antenna in the top plate 21.

According to an embodiment of the present disclosure, the surface outer electrode 2332 connected to one end of the relay coil 2331 and surrounding the relay coil 2331, and the surface inner electrode 2333 connected to the other end of the relay coil 2331 may be formed on a surface of the dielectric 2337. Also, the rear outer electrode 2334 formed to face the surface outer electrode 2332 and the rear inner electrode 2335 formed to face the surface inner electrode 2333 may be formed on the opposite surface (rear surface) of the dielectric 2337.

In this configuration, the relay unit 2330 may include the relay circuit 2339, which is a series resonance circuit in which the relay coil 2331, a capacitor of the inter-line capacitance C1, and a capacitor of the capacitor C2 are connected in series. Accordingly, the relay unit 2330 may be configured without an electronic component, and the restriction of use temperature depending on the electronic component may be eliminated. Also, because a resonance circuit may be configured only by forming a pattern on a surface and a rear surface of a dielectric, there is no need for physical connection between other circuit boards.

According to an embodiment of the present disclosure, a connection wiring between the rear outer electrode 2334 and the rear inner electrode 2335 may extend to be orthogonal to a wiring constituting the relay coil 2331, thereby reducing communication noise.

Preferred embodiments have been described as examples of the technology of the present disclosure. However, the technology of the present disclosure is not limited thereto, and may be applied to embodiments in which changes, substitutions, additions, omissions, and the like are appropriately performed. Also, in elements described in the accompanying drawings and the detailed description, elements that are not essential for solving problems may also be included. Accordingly, even when these non-essential elements are described in the accompanying drawings or the detailed description, it should not be recognized that these non-essential elements are essential.

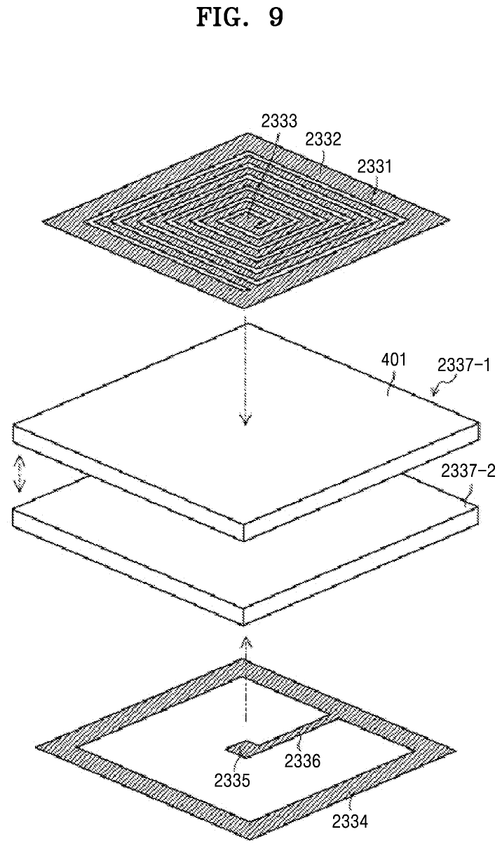

For example, configurations as shown in FIGS. 9 to 11 are also possible for the above embodiment.

FIG. 9 illustrates a configuration of a relay unit, according to an embodiment of the present disclosure.

Referring to FIG. 9, the relay unit 2330 may include two dielectrics, that is, first and second dielectrics 2337-1 and 2337-2.

For example, the relay coil 2331, the surface outer electrode 2332, and the surface inner electrode 2333 may be formed on a surface of the first dielectric 2337-1, and, the rear outer electrode 2334, the rear inner electrode 2335, and the connection wiring 2336 may be formed on a surface of the second dielectric 2337-2. Also, rear surfaces of the first dielectric 2337-1 and the second dielectric 2337-2 are aligned and adhered to each other.

The embodiment shows an example in which a capacitor constituting the relay circuit 2339 of the relay unit 2330 is implemented with the inter-line capacitance C1 between the surface outer electrode 2332 and the rear outer electrode 2334 and the inter-line capacitance C2 between the surface inner electrode 2333 and the rear inner electrode 2335, but is not limited thereto.

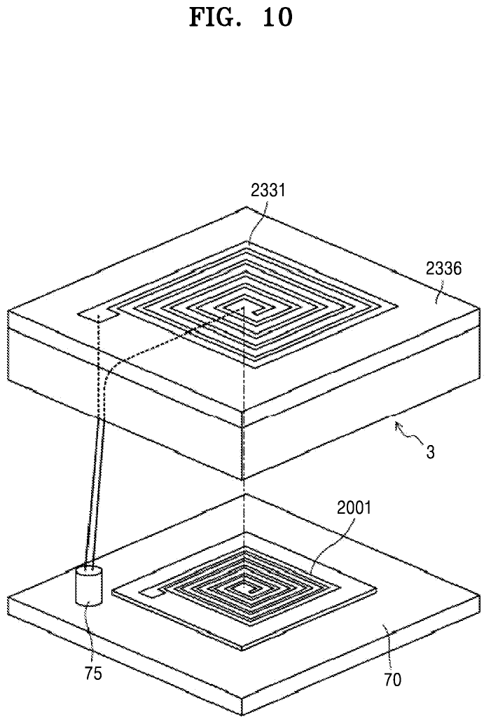

FIG. 10 illustrates a configuration of a relay unit, according to an embodiment of the present disclosure.

Referring to FIG. 10, a capacitor 75 constituting the relay circuit 2339 may be implemented by using an electronic component. In this case, the capacitor 75 may be mounted on the control board 70. The embodiment shows an example in which the relay unit 2330 is provided in each of a plurality of heating units 3, but is not limited thereto.

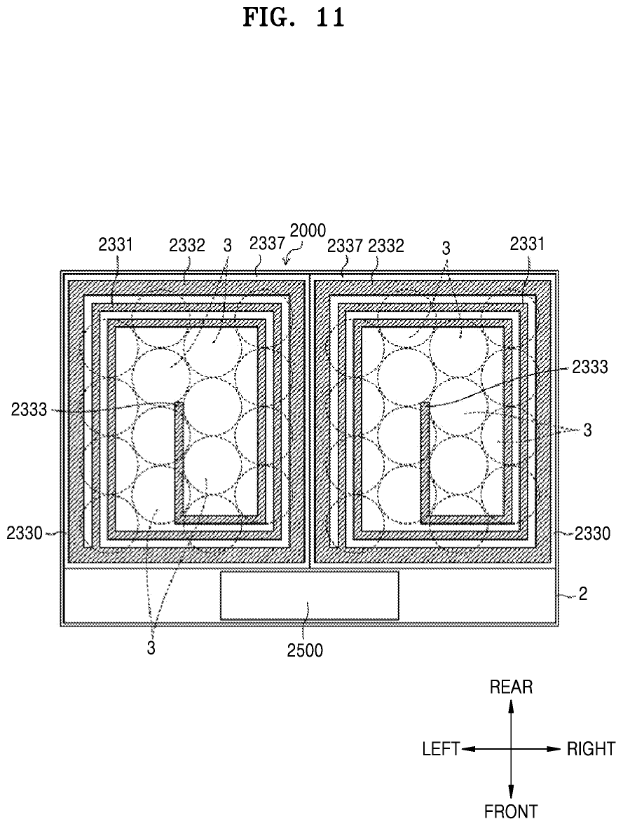

FIG. 11 illustrates a configuration of an electromagnetic induction device, according to an embodiment of the present disclosure.

Referring to FIG. 11, the relay unit 2330 is configured to cover a plurality of heating units 3. FIG. 11 illustrates an example in which two relay units 2330 are arranged side by side in left and right directions for a free-location type electromagnetic induction device 2000.

An arrangement or configuration of the relay unit 2330 is the same as described above. For example, the relay unit 2330 may be located between the top plate 21 of the case 2 and the working coil (or induction coil) 2120, and may include the plate-like or sheet-like dielectric 2337 extending along the top plate 21. Further, the relay coil 2331 and the surface outer and inner electrodes 2332 and 2333 may be formed on a surface of the dielectric 2337, and the rear outer and inner electrodes 2334 and 2335 may be formed on a rear surface to respectively face the surface outer and inner electrodes 2332 and 2333. According to this configuration, the same effect as those of the above embodiments may be obtained. Also, the dielectric 2337 is not limited to a circular shape, and may be rectangular as shown in FIG. 11.

Also, according to an embodiment of the present disclosure, although the surface inner electrode 2333 and the rear inner electrode 2335 are spaced apart from each other to face each other and the inter-line capacitance C2 is formed between the surface inner electrodes 2333 and the rear inner electrode 2335, the present disclosure is not limited thereto. For example, the surface inner electrode 2333 and the rear inner electrode 2335 may be directly connected to each other by using a hole (eyelet) or the like. In this case, a series resonance circuit is configured with the relay coil 2331 and the inter-line capacitance C1 between the surface outer electrode 2332 and the rear outer electrode 2334.

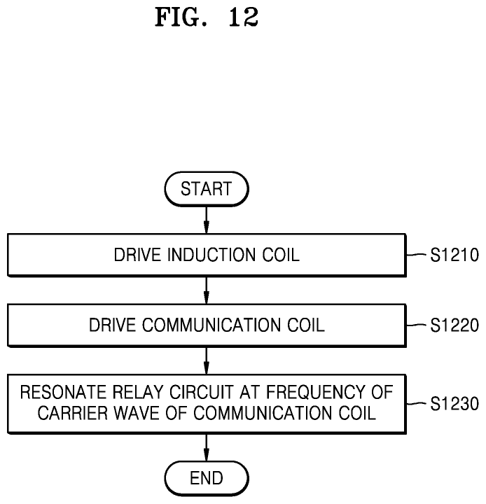

FIG. 12 is a flowchart of an electromagnetic induction method, according to an embodiment of the present disclosure.

The electromagnetic induction device 2000 according to an embodiment of the present disclosure includes a wireless power transmission unit and a communication unit.

The wireless power transmission unit includes an induction coil configured to generate a magnetic flux in an up-down direction and an inverter circuit configured to drive the induction coil. The communication unit is configured to communicate with an external device located above the induction coil, and includes a communication coil and a relay circuit, and the relay circuit includes a relay coil.

In operation S1210, the wireless power transmission unit drives the inverter circuit to drive the induction coil, and when the induction coil is driven, a magnetic flux in an up-down direction is generated.

In operation S1220, the communication unit may drive the communication coil to communicate with the external device located above the induction coil.

In operation S1230, the relay circuit resonates at a frequency of a carrier wave of the communication coil so that the relay coil is magnetically coupled to the communication coil.

When the relay circuit resonates at the frequency of the carrier wave of the communication coil, a leakage flux from the communication coil may be amplified, and the relay coil and a communication coil of the external device may be magnetically coupled to transmit a carrier wave output from the communication coil to a communication circuit of the external device.

In this case, the communication coil is located under the induction coil to be aligned with the induction coil so that a carrier wave having a frequency different from a driving frequency of the induction coil is output in a direction orthogonal to the induction coil, and the relay circuit is located over the induction coil to be aligned with the induction coil.

A method according to an embodiment of the present disclosure may be embodied as program commands executable by various computer means and may be recorded on a computer-readable recording medium. The computer-readable recording medium may include program commands, data files, and data structures separately or in combinations. The program commands recorded on the medium may be specially designed and configured for the present disclosure or may be well-known to and be usable by one of ordinary skill in the art of computer software. Examples of the computer-readable recording medium include a magnetic medium such as a hard disk, a floppy disk, or a magnetic tape, an optical medium such as a compact disc read-only memory (CD-ROM) or a digital versatile disc (DVD), a magneto-optical medium such as a floptical disk, and a hardware device specially configured to store and execute program commands such as a ROM, a random-access memory (RAM), or a flash memory. Examples of the program commands include advanced language code that may be executed by a computer by using an interpreter or the like as well as machine language code made by a compiler.

Some embodiments of the present disclosure may also be realized in the form of a recording medium including instructions executable by a computer, such as a program module executed by a computer. A computer-readable medium may be an arbitrary available medium accessible by a computer, and includes all volatile and non-volatile media and separable and non-separable media. Also, examples of the computer-readable medium may include a computer storage medium and a communication medium. Examples of the computer storage medium include all volatile and non-volatile media and separable and non-separable media, which have been implemented by an arbitrary method or technology, for storing information such as computer-readable instructions, data structures, program modules, and other data. The communication medium generally includes a computer-readable instructions, a data structure, a program module, other data of a modulated data signal such as a carrier wave, or another transmission mechanism, and an example thereof includes an arbitrary information transmission medium. Some embodiments of the present disclosure may also be implemented as a computer program or a computer program product including instructions executable by a computer, such as a computer program executed by a computer.

A machine-readable storage medium may be provided as a non-transitory storage medium. Here, ‘non-transitory’ means that the storage medium does not include a signal (e.g., an electromagnetic wave) and is tangible, but does not distinguish whether data is stored semi-permanently or temporarily in the storage medium. For example, the ‘non-transitory storage medium’ may include a buffer in which data is temporarily stored.

According to an embodiment, methods according to various embodiments of the present disclosure may be provided in a computer program product. The computer program product is a product purchasable between a seller and a purchaser. The computer program product may be distributed in the form of a machine-readable storage medium (e.g., a compact disc read-only memory (CD-ROM)), or distributed (e.g., downloaded or uploaded) online via an application store or between two user devices (e.g., smart phones) directly. When distributed online, at least part of the computer program product (e.g., a downloadable application) may be temporarily generated or at least temporarily stored in a machine-readable storage medium, such as a memory of a server of a manufacturer, a server of an application store, or a relay server.

Methods according to the claims or the embodiments of the present disclosure described herein may include hardware, software, or a combination of hardware and software.

When the methods are implemented by software, a computer-readable storage medium or a computer program product storing one or more programs (software modules) may be provided. The one or more programs that are stored in the computer-readable storage medium or the computer program product are configured to be executable by one or more processors in an electronic device. The one or more programs include instructions for allowing the electronic device to execute the methods according to the claims or the embodiments of the present disclosure.

The programs (e.g., software modules or software) may be stored in a random-access memory (RAM), a non-volatile memory including a flash memory, a read-only memory (ROM), an electrically erasable programmable read-only memory (EEPROM), a magnetic disc storage device, a compact disc-ROM (CD-ROM), a digital versatile disc (DVD), another optical storage device, or a magnetic cassette. Alternatively, the programs may be stored in a memory including any combination of some or all of the above storage media. Also, a plurality of constituent memories may be provided.

Also, the programs may be stored in an attachable storage device that is accessible through a communication network, such as the Internet, an intranet, a local area network (LAN), a wide LAN (WLAN), or a storage area network (SAN), or a combination thereof. Such a storage device may access, via an external port, a device for performing embodiments of the present disclosure. Furthermore, an additional storage device on the communication network may access the device for performing embodiments of the present disclosure.

In the present disclosure, the term “computer program product” or “computer-readable recording medium” is used to totally indicate a memory, a hard disk mounted in a hard disk drive, and a medium such as a signal. The ‘computer program product’ or ‘computer-readable medium’ provides software configured of instructions for setting a length of a timer for receiving a missing data packet, based on network metrics corresponding to a determined event according to the present disclosure, to a computer system.

The machine-readable storage medium may be provided as a non-transitory storage medium. Here, ‘non-transitory’ means that the storage medium does not include a signal (e.g., an electromagnetic wave) and is tangible, but does not distinguish whether data is stored semi-permanently or temporarily in the storage medium. For example, the ‘non-transitory storage medium’ may include a buffer in which data is temporarily stored.

According to an embodiment, methods according to various embodiments of the present disclosure may be provided in a computer program product. The computer program product is a product purchasable between a seller and a purchaser. The computer program product may be distributed in the form of a machine-readable storage medium (e.g., a compact disc read-only memory (CD-ROM)), or distributed (e.g., downloaded or uploaded) online via an application store (e.g., Play Store™) or between two user devices (e.g., smartphones) directly. When distributed online, at least part of the computer program product (e.g., a downloadable application) may be temporarily generated or at least temporarily stored in a machine-readable storage medium, such as a memory of a server of a manufacturer, a server of an application store, or a relay server.

In specific embodiments of the present disclosure described above, elements included in the present disclosure are expressed as singular or plural according to the specific embodiments of the present disclosure. However, singular or plural representations are selected appropriately for the sake of convenience of explanation, the present disclosure is not limited to the singular or plural elements, and even expressed as a singular element, it may be composed of plural elements, and vice versa.

Although specific embodiments of the disclosure are described in the detailed description of the present disclosure, various modifications may be made without departing from the scope of the present disclosure. Hence, the scope of the disclosure is not limited to the above embodiments, and may be defined by not only the following claims but also equivalents thereof.

1. An electromagnetic induction device comprising:
a wireless power transmission unit including an induction coil configured to generate a magnetic flux in an up-down direction to heat an external device located above the induction coil by induction heating; and
a communication unit including a communication coil configured to output a carrier wave, and a relay circuit configured to resonate at a frequency of the carrier wave, to wirelessly communicate with the external device.

2. The electromagnetic induction device of claim 1, wherein
the carrier wave has a frequency different from a driving frequency of the induction coil,
the communication coil is located under the induction coil and aligned with the induction coil so that the carrier wave is output in a direction orthogonal to the induction coil, and
the relay circuit is located over the induction coil and aligned with the induction coil.

3. The electromagnetic induction device of claim 1, wherein the relay circuit is on a surface of a dielectric that is plate-like or sheet-like.

4. The electromagnetic induction device of claim 3, wherein the relay circuit includes:
a relay coil,
a first surface electrode on a front surface of the dielectric, connected to a first end of the relay coil, and surrounding the relay coil, and
a first rear electrode on a rear surface of the dielectric and facing the first surface electrode.

5. The electromagnetic induction device of claim 4, wherein the relay circuit further includes:
a second surface electrode on the front surface of the dielectric and connected to a second end of the relay coil, and
a second rear electrode on the rear surface of the dielectric, connected to the first rear electrode, and facing the second surface electrode.

6. The electromagnetic induction device of claim 5, wherein the relay circuit further includes:
a connection wiring between the first rear electrode and the second rear electrode, and extending orthogonally to a wiring constituting the relay coil.

7. The electromagnetic induction device of claim 1, wherein the relay circuit includes:
a relay coil having an outer diameter greater than an outer diameter of the induction coil.

8. A method of operating an electromagnetic induction device, the electromagnetic induction device including a wireless power transmission unit that includes an induction coil configured to generate a magnetic flux in an up-down direction, and a communication unit that includes a communication coil configured to output a carrier wave, and a relay circuit configured to resonate at a frequency of the carrier wave, the method comprising:
driving the induction coil to generate the magnetic flux so that an external device located above the induction coil is heated by induction heating; and
driving the communication coil to output the carrier wave, and resonating the relay circuit at the frequency of the carrier wave, to wireless communicate with the external device.

9. The method of claim 8, wherein
the carrier wave has a frequency different from a driving frequency of the induction coil,
the communication coil is located under the induction coil and aligned with the induction coil so that the carrier wave is output in a direction orthogonal to the induction coil, and
the relay circuit is located over the induction coil and aligned with the induction coil.

10. The method of claim 8, wherein the relay circuit is on a surface of a dielectric that is plate-like or sheet-like.

11. The method of claim 10, wherein the relay circuit includes:
a relay coil,
a first surface electrode on a front surface of the dielectric, connected to a first end of the relay coil, and surrounding the relay coil, and
a first rear electrode on a rear surface of the dielectric and facing the first surface electrode.

12. The method of claim 11, wherein the relay circuit further includes:
a second surface electrode on the front surface of the dielectric and connected to a second end of the relay coil, and
a second rear electrode on the rear surface of the dielectric, connected to the first rear electrode, and facing the second surface electrode.

13. The method of claim 12, wherein the relay circuit further includes:
a connection wiring between the first rear electrode and the second rear electrode, and extending orthogonally to a wiring constituting the relay coil.

14. The method of claim 8, wherein the relay circuit includes a relay coil having an outer diameter greater than an outer diameter of the induction coil.

15. A non-transitory computer-readable recording medium having recorded thereon a computer program for executing the method according to claim 8.
